(19) United States
(12) Patent Application Publication
(10) Pub. No.: US 2009/0161569 A1
(43) Pub. Date: Jun. 25, 2009

(54) SYSTEM AND METHOD FOR FACILITATING CARRIER ETHERNET PERFORMANCE AND QUALITY MEASUREMENTS

(76) Inventor: Andrew Corlett, San Clemente, CA (US)

Correspondence Address: BRUCE B. BRUNDA;STETINA BRUNDA GARRED & BRUCKER, Suite 250, 75 Enterprise, Aliso Viejo, CA, 92656, US

(21) Appl. No.: 12/030,164

(22) Filed: Feb. 12, 2008

Related U.S. Application Data
(60) Provisional application No. 61/008,768, filed on Dec. 24, 2007.

(51) Int. Cl. G06F 11/00

(52) U.S. Cl. 370/252

(57) ABSTRACT

An Ethernet metric system and methodology which provides comparable measurements over a data link layer for use in network engineering and Service Provider (SP) performance monitoring. The Ethernet metric system of the present invention utilizes a measurement appliance known as a nodal member for measuring various Ethernet and IP metrics. A plurality of nodal members is used to make one-way or round-trip measurements over asymmetrical paths. The system includes a database for storing measurement data recorded by the plurality of nodal members. A workstation is also contemplated to facilitate system configuration and reporting of measurement data. The system further includes at least one service daemon for interfacing between the plurality of nodal members and the database. Additionally, the service daemon instructs the plurality of nodal members to create vectors and obtain vector configuration from the database. The service daemon processes results data transmitted from the nodal members to the database.

### CROSS-REFERENCE TO RELATED APPLICATIONS

The present application claims priority to U.S. Provisional Application No. 61/008,768, filed Dec. 24, 2007.

### STATEMENT RE: FEDERALLY SPONSORED RESEARCH/DEVELOPMENT

Not Applicable

### BACKGROUND

1. Technical Field

This invention relates generally to measuring the quality and performance of a Carrier Ethernet system and, more particularly, to a system and methodology for quality and functionality testing of the Ethernet layer (Data Link Layer) and subsequent layers including the Network, Transport, Session, Presentation, and Application layer using Ethernet metrics.

2. Related Art

The success of Ethernet for Local Area Network (LAN) transport technology has led to Ethernet becoming the standard interface for network-capable devices. Ethernet has since become the most popular and most widely deployed network technology in the world. In business, reliable and efficient access to information is an important asset in the quest to achieve a competitive advantage. An accelerating need for bandwidth as a result of home and business usage has spawned an Ethernet-working infrastructure managed by a new industry of Service Providers (SPs). SPs are beginning to rely on Ethernet as a technology within their service network. LANs are faster and more reliable. Fiber optic cables have allowed LAN technologies to connect Ethernet-capable devices tens of kilometers apart, while at the same time greatly improving the speed and reliability of wide area networks (WANs). For example, Ethernet maybe used as a pure layer 2 transport mechanism, IP VPN services, and broadband technologies for delivery of multiple services to residential customers. Further, Ethernet has the ability to converge multiple services onto a common transport medium. As the complexity and connectivity of the multi-layer Internet communication system grows, expanded usage of audio, voice, and video across the Internet seems certain to place unprecedented demand on bandwidth available now and in the foreseeable future. In this context, it is clear that quality of service is an important and definitive issue for SPs and their customer base.

In order to enable control and monitoring capability over the data link layer (layer 2) and subsequent layers, there is a clear need for precise and scalable metric tools that can give SPs real-time measurements across nodes and groups of nodes, between SPs and their customers, for a variety of packet types. Ethernet ready devices typically implement only the bottom two layers of the Open Systems Interconnection (OSI) protocol. The availability of a practical and versatile system capable of real-time measurement of one-way loss, delay, jitter, and other parameters defining the quality of service metrics, therefore, would greatly enhance Carrier Ethernet functionality and, at the same time, provide a competitive edge for SPs who can consistently demonstrate high levels of quality of service performance.

Quality of Service performance is currently measured from the SP provider edges. However, measurement between the SP provider edges ignores Quality of Service and functionality between the SPs customer and the SP provider edge. In particular, it is important to determine the quality of service and functionality between the SP provider edge and the customer premise equipment (CPE). The CPE is any terminal and associated equipment and inside wiring located at a customer (subscriber's) premise and connected with a carrier's telecommunication channel(s) at a particular location. The CPE may include telephones, DSL modems, cable modems or set-top boxes for use with SPs communication service. A round-trip measurement between the SP provider edge and the CPE is also known as a local loop. Thus, a more complete and therefore more accurate quality of service and functionality measurement includes the SP provider edges and the local loop measurement. Additionally, a customer or subscriber of the SP may have two or more locations across a network. In this situation it is desirable to obtain a quality of service and functionality measurement between CPE's at the various customer locations across the network. For example, where the customer has two locations on the network, a CPE to CPE measurement will include a measurement between the SP provider edges and two local loop measurements. Each local loop measurement comprises a round-trip measurement between the SP provider edge and a CPE. Currently, a network measurement between CPE's is more difficult than an already difficult measurement between the SP provider edges. Furthermore, if scaleability is a factor, the difficulty level for CPE to CPE network measurements increases.

Because Carrier Ethernet performance and functionality between the provider edges does not provide a complete representation of the network, it is important to include local loop measurements to obtain Carrier Ethernet performance and functionality between CPE's. One method to obtain network performance measurements between CPE's includes replacing the CPE with the SP provider edge. For example, the SP provider edges may be located at the customer location. Thus, the measurement between the SP provider edges in this case includes a more complete measurement without requiring local loop measurements. However, replacing the CPE with an SP provider edge is not practical. The benefit gained is outweighed by the sharp increase in operating costs for the SPs to replace every CPE on the network with an SP provider edge. Others have attempted to gather metrics data and record benchmarks and have succeeded, but apparently only at the network layer and subsequent layers. Measurement data generated at the network layer can then only be compared to measurements performed on the same or similar applications, as well as on the same platform. Further, these measurements are not capable of determining the quality and functionality of Carrier Ethernet. Prior measurement techniques have not produced data link layer measurements of the type desired by engineers for Carrier Ethernet that are comparable cross application and cross platform.

Additionally, existing and prior data measurement gathering systems are bandwidth intensive. Because prior measurement techniques use significant bandwidth, the number of measurement points that the system can analyze is limited. Thus, once the system has reached only a few dozen measurement points, the system will break down due to bandwidth limitations. Moreover, customers are not interested in a Carrier Ethernet measurement system that will drastically decrease the efficiency of the Ethernet due to the amount of traffic produced by the measurement technique. These types of bandwidth intensive measurement techniques undesirably prevent the measurement system from being scalable to have functional significance in a real-world environment.

Accordingly, those skilled in the art have recognized the need for a method and system capable of measuring Carrier Ethernet metrics in a scalable environment to produce accurate and comparable measurements. Additionally, there is a need in the art for Ethernet metrics data measured at the data link layer (layer 2). Additionally, there is also a need in the art for an improved method of local loop quality and functionality measurements at the data link layer. The present invention clearly addresses these and other needs.

### BRIEF SUMMARY

Briefly, and in general terms, the present invention resolves the above and other problems by providing an Ethernet metric system and methodology which provides comparable measurements over a data link layer for use in network engineering and Service Provider (SP) performance monitoring. The Ethernet metric system of the present invention utilizes a measurement appliance known as a nodal member or a level 9 cNode agent. Additionally, the system may include a nodal agent known as a level 1 or a level 3 cNode agent, depending upon its capabilities. The system is used for performing measurements over a network. The measurements may be made at the Ethernet layer of the network or subsequent layers such as the network layer or transport layer by way of example and not of limitation. The system includes a plurality of nodal members between which one-way or round-trip measurements are performed over asymmetrical paths. The number of nodal members used as measurement points is scaleable. The nodal members include synchronized timing systems. Preferably, in this regard, the nodal members support Network Time Protocol (NTP) timing synchronization and Global Positioning System (GPS) timing synchronization.

The nodal member is a hardware based probe that may be located at the provider edge of the Service Provider (SP) and/or at the customer location. The one-way and the round-trip measurements are performed by the nodal members at the data link layer or any preferable layer above the data link layer and provide cross-application and cross-platform comparable measurements. The nodal member is a hardware device that performs Quality of Service (QoS) measurements across network links and VPNs and has the ability to measure multiple QoS services over Carrier Ethernet and IP networks. In accordance with another aspect of the present invention, the nodal members of the Ethernet metric system perform processing of the measurement data. Preferably, the nodal members implement a processing algorithm on raw measurement data recorded for each measurement period. This processing algorithm compresses the raw measurement data. In one embodiment of the present invention, the raw measurement data is compressed to approximately 1 kilobyte per five minute measurement period per vector. Preferably, the distributed processing among the nodal members allows centralized processing of the raw measurement data to be eliminated. The Ethernet metric system minimizes network traffic by utilizing the nodal members for distributed processing. Preferably, the Ethernet metric system eliminates single point failure by utilizing the nodal members for distributed processing.

In accordance with another aspect of the present invention, the nodal members of the Ethernet metric system are true Internetworking devices, which support TCP/IP, SNMP, SSH, Telnet, TFTP, dhcp, BootP, RARP, DNS resolver, traceroute, and ping functions. Preferably, the nodal members include multiple on-board processors, enabling one processor to handle management processes and another processor to handle measurement processes. In one embodiment of the Ethernet metric system, each nodal member is capable of automatic software updating in synchronization with other nodal members in the nodal network for minimal loss of measurement time and enhanced scalability.

In accordance with another aspect of the present invention, the nodal members of the Ethernet metric system are autonomous devices that are capable of generating measurement packets, performing one-way measurements and round-trip measurements at the data link layer, processing measurement data, and temporarily storing measurement data, despite a service daemon or database outage. Preferably, the nodal members are functional without requiring a TCP session with the service daemon. In one embodiment of the Ethernet metric system, the nodal members employ a dual power system to minimize power failures. In response to a nodal member failure, the nodal member preferably records the reason for the failure, and automatically reestablishes the nodal member to the nodal network upon resolution of the failure. The present invention contemplates further redundancy of the method and system with the intention of increasing reliability of the system. This is accomplished by including a substitute nodal member in case there is a nodal member failure. If there is a failure for any reason, the nodal member can replace the failed nodal member.

In accordance with yet another aspect of the present invention, the nodal members of the Ethernet metric system implement hardware time stamping. Hardware time stamp is more accurate than software time stamping. This system architecture configuration offloads the processor-intensive activity of time stamping and frees up processing power. Each nodal member includes an output buffer, and during the hardware time stamping, header information and data information preferably fill the output buffer before a time stamp is applied to the output buffer.

The system further includes a database for storing measurement data recorded by the nodal members. In accordance with another aspect of the present invention, the database of the Ethernet metric system is SQL compliant. In one embodiment of the Ethernet metric system, the database stores vector configuration information and results of the measurement data to allow generation of true averages in response to user defined parameters. The data stored in the database preferably includes, by way of example only, and not by way of limitation: Delay (minimum, maximum, average, standard deviation, percentile), Delay (MEF), Delay (untrimmed), Jitter/Delay Variation (minimum, maximum, average, standard deviation, percentile), Jitter/Delay Variation (untrimmed), Packet Loss, Availability, Outages (minimum, maximum, total, average length), Rate Ratio, R-Factor (G.729, G.711), Transmit Bit Rate, Transmit Packet Rate, Receive Bit Rate (minimum, maximum, average, standard deviation, interval), Receive Packet Rate (minimum, maximum, average, standard deviation, interval), Packets Out-of-Order, Groups of Packets Out-of-Order, Sequential Packets Lost (minimum, maximum, average, standard deviation), Sequential Packets Dropped (minimum, maximum, average, standard deviation), Packets Dropped, Packets Duplicated (number duplicated, minimum, maximum, average), Packets Tagged (number tagged, copy of first tag, copy of last tag), Packets Untagged, VLAN ID (mismatches, changes), VLAN CoS (mismatches, changes), Destination Address (unicasts, multicasts, broadcasts, mismatches, changes), Source Address (mismatches, changes), Transmit Interface (speed, duplex, speed changed flag, duplex change flag), Receive Interface (speed, duplex, speed changed flag, duplex change flag), Packets with CRC Errors, Packets with Alignment Errors, Packets Too Short, Packets Too Long (Jabbers), Accumulative to Transmit Interface (good frames, collisions, excessive collisions), Accumulative to Receive Interface (CRC errors, alignment errors, resource errors, short frames), DSCP (changes, copy of first value, copy of last value), Packets Dropped Due to Missing Fragment, Packets Fragmented (number fragmented, minimum fragments, maximum fragments, average number fragments), L3 IP Header Corrupted (UDP/TCP), Hop Count (changes, minimum, maximum, average), L3 IP Protocol (mismatches, changes), Record/Strict/Loose Route Info (number record, copy of first set, copy of last set), Payload Corrupted, Measurement Header Corrupted, cNode Level 1 Agent (MAC address, invalid responses, flag if Level 1 results), Transmitting System Synchronization (status, changed flag), Receiving System Synchronization (status, changed flag), Packets (transmitted, received), Bytes (transmitted, received), Bursts received, Mismatched timestamps, Transmitting System (system type, version, minimum temperature, maximum temperature, average temperature) and Receiving System (system type, version, minimum temperature, maximum temperature, average temperature).

The system further includes a workstation operatively associated with the database. The workstation facilitates system configuration and reporting of measurement data. In accordance with still another aspect of the present invention, the workstation utilizes a browser based interface to provide system reports and management functions to a user from any computer connected to the Internet without requiring specific hardware or software. Preferably, the user interface of the workstation is alterable without modifying the underlying system architecture. However, the system is capable of performing measurements and storing measurement data without dependence upon the user interface.

The system further includes at least one service daemon. The service daemon interfaces with the plurality of nodal members and the database. The service daemon instructs the plurality of nodal members to create vectors. Furthermore, the service daemon obtains vector configuration information from the database. The service daemon processes results data transmitted from the plurality of nodal members to the database. The system utilizes a vector based measurement system to achieve service-based, comparable measurements. Preferably, the vector based measurement system defines a vector by a source, a destination, and a service type. The source and destination are typically referred to as end points. Multiple vectors can be created or generated between two end points to measure multiple classes of services. Such classes of service may include by way of example only, and not by way of limitation, HTTP, VoIP, FTP, STP, and GARP.

The system may also include an application server that interfaces between the workstation and the database for providing system configuration and results display. In accordance with another aspect of the present invention, the application server of the Ethernet metric system interfaces with the management/reporting workstation via HTML, Java, or CGI for system configuration and results display. Preferably, the service daemon performs automatic error recovery to retrieve missing measurement data when measurement data is lost in transmission. In one embodiment of the Ethernet metric system, the nodal members continue to perform measurements and store measurement data in response to a service daemon failure until a replacement service daemon is activated. In another embodiment of the present invention, the database and a web-based application function together to provide load balancing and redundancy for increased reliability of the method and system.

In accordance with yet another aspect of the present invention, the Ethernet metric system implements an access protocol that is selectively configurable to allow third party applications to access the system. Preferably, the workstation utilizes multiple levels of access rights, including, by way of example only, and not by way of limitation, administrator level access rights and user level access rights. The administrator level access rights preferably allow various types of system configuration, including the creation/modification/deletion of the nodal members, vectors, service types, logical groups of vectors, and user access lists, while the user level access rights preferably allow only report viewing.

In accordance with another aspect of the present invention, the Ethernet metric system implements a Scaleable Measurement Application Protocol (SMAP), which is a non-processor intensive, non-bandwidth intensive protocol for transmitting pre-processed, compacted measurement data. The SMAP protocol has the capability of using XML programming language. In one embodiment of the Ethernet metric system, measurement data from each measurement period is sent from the nodal member to the database via the SMAP protocol. The nodal members also communicate with each other and obtain results data using SMAP protocol. Moreover, configuration data and status data are also sent via SMAP protocol.

In accordance with still another aspect of the present invention, the one-way and round-trip measurements performed by the nodal members at the data link layer provide cross application and cross platform comparable measurements. In one embodiment of the present invention, the Ethernet metric system utilizes a vector based measurement system to achieve service-based, comparable measurements. Preferably, the vector based measurement system defines a vector by a source, a destination, and a service type. The Ethernet metric system is preferably configured so that vectors in the vector based measurement system are capable of disablement without deletion from the database.

In accordance with another aspect of the present invention, the Ethernet metric system provides user-definable groupings of vectors for facilitating vector display and reporting. The nodal members in the nodal network are capable of user-defined customizable groupings for area-specific measurement reporting. In the Ethernet metric system of the present invention, the customizable groupings of nodal members are capable of overlapping each other. The system further preferably allows the measurement reports generated by the system to be produced in both standard formats and customized formats. The system may also include an application programming interface (API) for accessing the system remotely.

In accordance with still another aspect of the present invention, the nodal members of the Ethernet metric system generate and transmit measurement packets in order to perform round-trip and one-way measurements at the data link layer. Specifically, the measurement packets have a format that preferably includes an Ethernet header, optional LLC/SNAP header, optional IP header, optional IP routing options, UDP/TCP header, payload, and Scalable Measurement Header (SMH). In one embodiment of the network metric system, CRC's are calculated on the measurement packets for payload, UDP/TCP header, and SMH.

In accordance with yet another aspect of the present invention, the Ethernet metric system facilitates user-definable bandwidth allocation for measurement traffic. Preferably, each nodal member automatically calculates the rate at which measurement packets are generated based upon the number of vectors, packet size, and the bandwidth allocation. In one embodiment of the present invention, the Ethernet metric system performs accurate measurements at a low sampling rate.

Yet another embodiment of the present invention is directed towards a measurement system for performing measurements over a network that also performs a readiness test. The system includes a nodal network, a measurement database, a user interface workstation, an application server, and a service daemon. The nodal network includes a plurality of nodal members between which round-trip measurements are performed at the data link layer. Additionally, one-way measurements are performed between the nodal members at the data link layer. The workstation provides a user interface for system configuration, including sending vector configuration information to the database, as well as reporting of measurement data. The application server interfaces between the database and the workstation for system configuration and results display (obtaining the results data from the database and preparing the data for display). The service daemon interfaces with the nodal members and the database. In the Ethernet metric system of the present invention, a transmitting nodal member performs a readiness test to ensure the willingness of a receiving nodal member to accept measurement traffic before the transmitting nodal member begins to transmit measurement traffic to the receiving nodal member.

In accordance with the present invention, the readiness test of the Ethernet metric system preferably includes: pinging the receiving nodal member; and performing a Go/No Go test using an SMAP protocol which is a non-processor intensive, non-bandwidth intensive protocol for the nodal members to communicate with each other. The Go/No Go test also may include a critical input for the measurement algorithms when computing the Ethernet metrics.

In further accordance with the present invention, the Go/No Go test of the Ethernet metric system is performed by a transmitting nodal member requesting and obtaining permission from a receiving device to transmit measurement traffic before the transmitting nodal member transmits the measurement traffic. This ensures protection against unwanted measurements being made on the nodal members, as well as against measurement traffic being sent to a non-nodal member receiving device. The readiness test verifies linkage and reachability of the nodal members before measurements are performed without burdening the network with unnecessary duplication of effort. Additionally, the transmitting nodal member and the receiving nodal member may negotiate a shared secret. This is done to determine if the SMH has been tampered with.

The present invention also contemplates a method for performing quality and functionality measurements over a network. The method includes performing round-trip measurements between a nodal member and a nodal agent over asymmetrical paths. The measurement may be performed at the Ethernet layer or subsequent layers in a scalable environment. The nodal agent may include a level 1 or level 3 cNode agent. The method further includes processing data produced from the round-trip measurements between the nodal member and the nodal agent. The processed measurement data is then transmitted from the nodal member to a database and analyzed. The round-trip measurement of the method may include transmitting a measurement packet from the nodal member to the nodal agent. The measurement packet includes a destination and a source address. The nodal agent receives the measurement packet. The original source and destination address of the measurement packet are altered. The source address is replaced with a source address value of the nodal agent. Further, the destination address of the measurement packet is replaced with the original source address of the measurement packet. Then, the measurement packet is retransmitted to the nodal member.

In one embodiment of the present invention, the level 1 cNode agent is a crucial component of a system that allows scientific, accurate, and scaleable measurements across operational networks providing network operators with detailed visibility into their networks, the ability for service providers to offer hard Service Level Agreements (SLAs) and the ability for enterprises to verify network quality. The level 1 cNode agent may be implemented within a vendor or customer device that will allow that device to be able to perform Carrier Ethernet and IP service level measurements when deployed on networks containing one or more nodal members. In another embodiment, it is contemplated that the level 1 cNode agent is a stand alone device identical to the specification that is implemented within a vendor's device. In accordance with one aspect of the present invention, the level 1 cNode agent includes a destination MAC address value. The destination MAC address value is a fixed value such that hardware chips (switching chips and MAC controllers) may be programmed to recognize measurement packets by utilizing already existing MAC address lookup and forwarding to the management function of a device. Any measurement packet that contains the fixed destination MAC address is turned around and transmitted back to the sending nodal member after modifying the source and destination MAC addresses. In another embodiment of the present invention the level 3 cNode agent is a component that has the ability to make one-way and round-trip measurements with the nodal members. The level 1 cNode agent is limited to round-trip measurements with the nodal members. Additionally, the level 3 cNode agent is capable of implementing the go/no go test as will be described in further detail below.

In further accordance with the present invention, a method for service verification of a Carrier Ethernet network. This aspect of the present invention contemplates using vector models to create vectors to implement function testing for a set amount of time. Rather than determining the performance of the Ethernet, the method determines the functioning of the Ethernet network. The nodal members transmit a manipulated measurement packet or SMH to other nodal members for one-way or round-trip functioning tests. The measurement packets are conformed to check for functionality by changing their parameters and creating multiple vector handlers. The service verification method by way of example and in no way limiting, may implement MEF 9 testing. MEF 9 is Abstract Test Suite for Ethernet Services at the UNI.

Other features and advantages of the present invention will become apparent from the following detailed description, taken in conjunction with the accompanying drawings, which illustrate by way of example, the features of the present invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram illustrating the system architecture for performance and functionality testing of various networks;

FIG. 2 is a diagram illustrating continuous measurements and transmission of computed results;

FIG. 3 is a diagram illustrating a multiprotocol label switching network;

FIG. 4 is a diagram illustrating the various parts of a measurement packet;

FIG. 5 is a screenshot of a user interface for editing service/packet type;

FIG. 6 is an exemplary schematic diagram of the electrical components of a nodal member; and

FIG. 7 is a second exemplary schematic diagram of the electrical components of the nodal member.

### DETAILED DESCRIPTION

The detailed description set forth below in connection with the appended drawings is intended as a description of an embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the scope of the invention. It is further understood that the use of relational terms such as first and second, and the like are used solely to distinguish one from another entity without necessarily requiring or implying any actual such relationship or order between such entities.

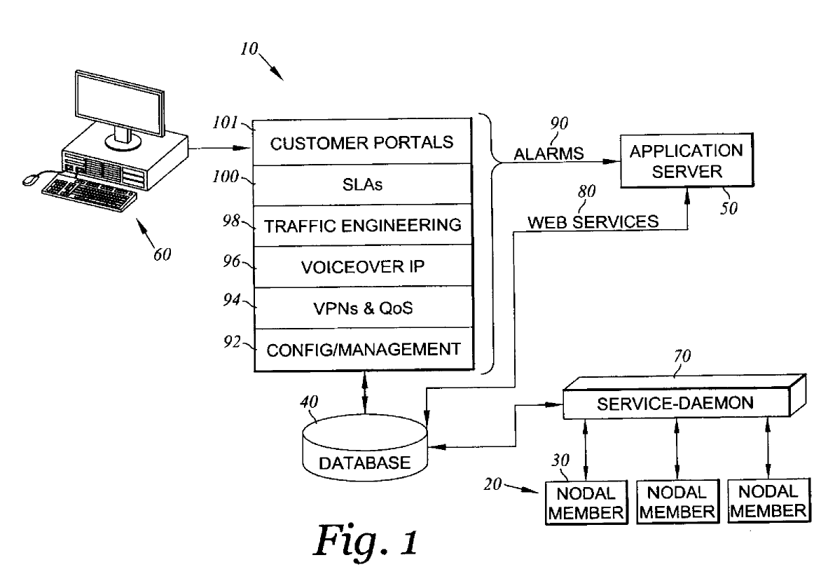

With reference to FIG. 1, an exemplary network metric system 10 and methodology, constructed in accordance with the present invention, provides comparable measurements over a network at the Carrier Ethernet layer, also known as the data link layer or layer 2 of the open systems interconnection model (OSI). Additionally, the network metric system 10 is capable of providing comparable measurements for layer 2 and above for use in network engineering and Service Provider (SP) performance monitoring. The network metric system 10 is capable of measuring one-way and/or round-trip Ethernet metrics in a scalable network environment to produce accurate, comparable measurements. Further, because the system 10 may be implemented over an already existing network, it provides redundancy, thereby increasing reliability of the system 10.

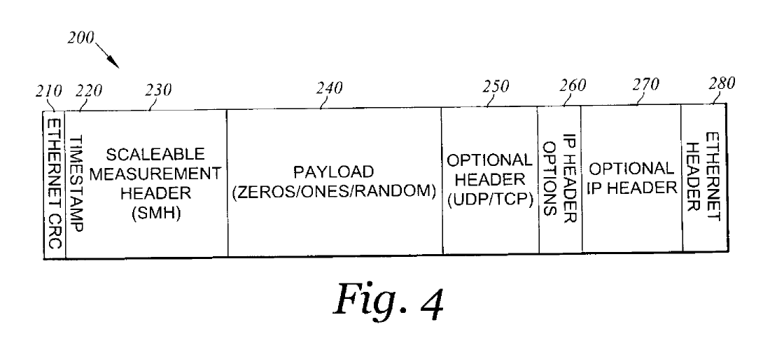

The network metric system 10 includes a nodal network 20, a database 40, an application server 50, a workstation 60, and at least one service daemon 70 that interfaces between the workstation 60, the nodal network 20, and the database 40. The nodal network 20 includes a plurality of nodal members 30. Each nodal member 30 from the nodal network 20 is a measurement appliance. The nodal members 30 may also be referred to as a level 9 cNode agent. The nodal members 30 have the ability to generate measurement packets 200 (as shown in FIG. 4) and compute one-way and round-trip statistics by processing a measurement algorithm. Additionally, the nodal members 30 include hardware-based packet time stamping with a nanosecond based clock and hard time synchronization such as a built in GPS unit. The nodal members 30 of the nodal network 20 are used as measurement points that are highly scalable, in order to allow accurate measurements to be performed in a network environment of virtually any size. The nodal members 30 are hardware based probes that perform Quality-of-Service (QoS) measurements across network links and Virtual Private Networks (VPNs) 94 and can measure multiple QoS 94 services over IP and Carrier Ethernet networks.

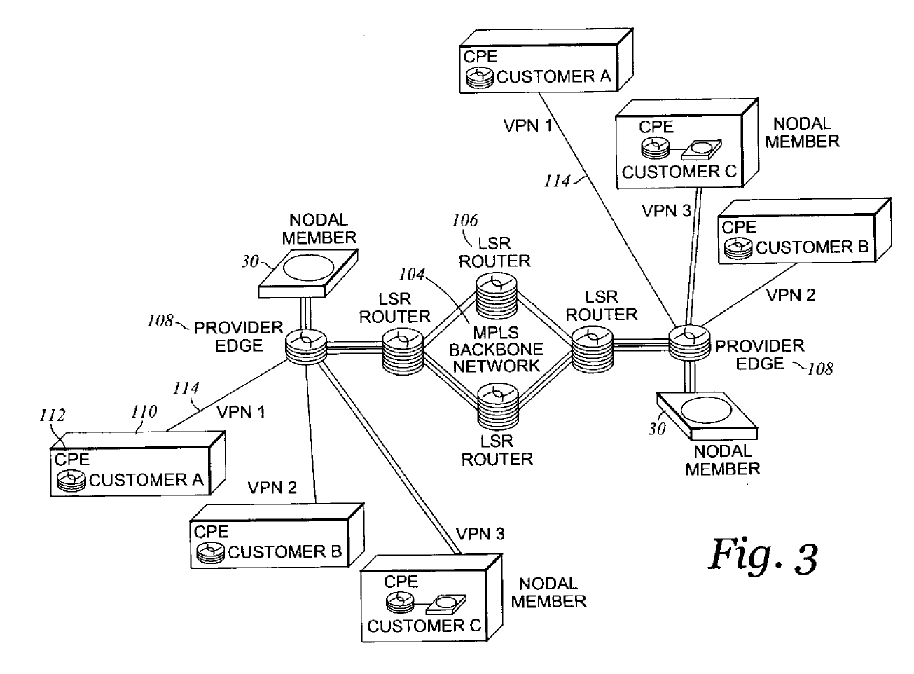

In another embodiment of the present invention, a nodal agent is an agent that runs on third-party vendor equipment such as Network Interface Devices (NIDs), switches, routers, and media converters by way of example and not of limitation. The nodal agent can recognize and receive measurement packets 200 from the nodal members 30 and loop the measurement packet 200 back to the nodal member 30. The nodal agent may also be referred to as a level 1 cNode agent. The nodal agents do not require data storage (RAM). Furthermore, the nodal agents include few basic operations per measurement packet 200 received from the nodal members 30. The nodal agent is designed to keep CPU and RAM overhead to a minimum. Essentially, the nodal agent loops measurement packets 200 back to the nodal member 30 so that an accurate round-trip measurement may be made. A measurement packet 200 being sent from the nodal member 30 to the nodal agent includes a destination address and a source address. The nodal agent after receiving the measurement packet 200, copies the value of the source address of the measurement packet into the destination address and the address value of the nodal agent is copied to the source address field of the measurement packet 200. After this is completed, the measurement packet 200 is re-transmitted to the nodal member 30. Additionally, a maximum transfer rate may be set for the measurement packets 200, such that if the maximum rate is exceeded, the measurement packet 200 will be dropped for security purposes. Furthermore, because the nodal agent does not inspect received measurement packets 200, a hacker sending bogus packets to be processed by the nodal agent will not cause the system 10 to crash. Measurement packets 200 being sent to the nodal agent may be kept to a minimal amount of bandwidth. There may also include an option to limit the number of responses the nodal agent may send. If such an option is utilized, the maximum rate may be set to at least 64 Kbps. An aspect of the present invention contemplates another slightly more sophisticated nodal agent. The nodal agent may be referred to as a Level 3 cNode agent. Level 3 cNode agents have the same capability as the Level 1 cNode agent and thus may be interchangeable with the Level 1 cNode agent. Additionally, Level 3 cNode agents are capable of modifying a measurement header 230 on the measurement packet 200 prior to looping the measurement packet back to the sending nodal member 30. Unlike the level 1 cNode agent, this allows for some characterization of one-way characteristics of the local loop 114 as shown in FIG. 3. Thus, the level 3 cNode agent adds a minimal amount of additional processing for each measurement packet 200 but does not require any significant data storage. Both the level 1 and level 3 cNode agents may be configured as stand alone devices.

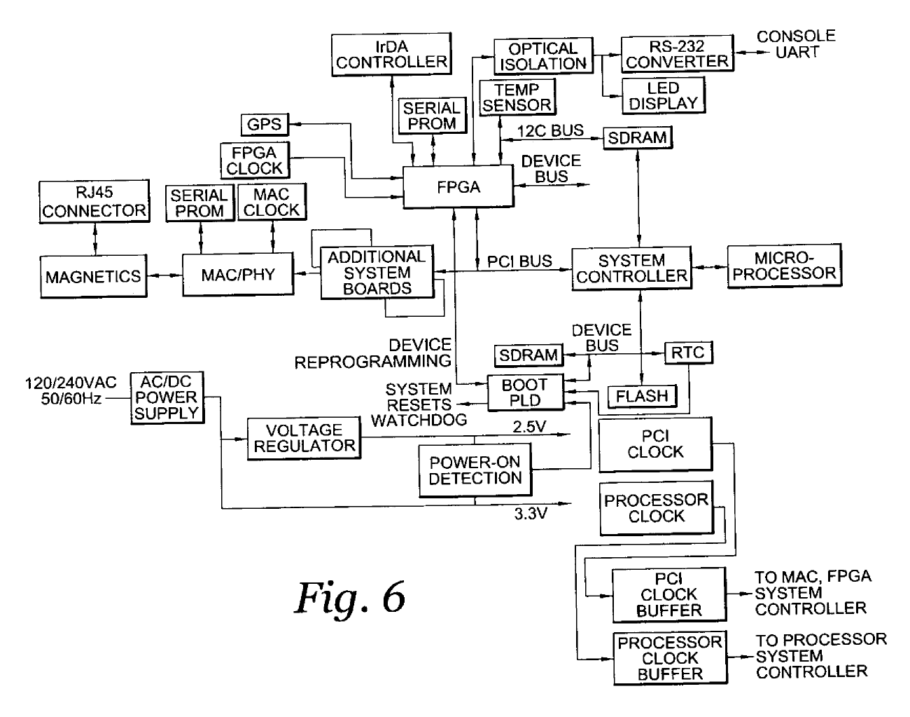

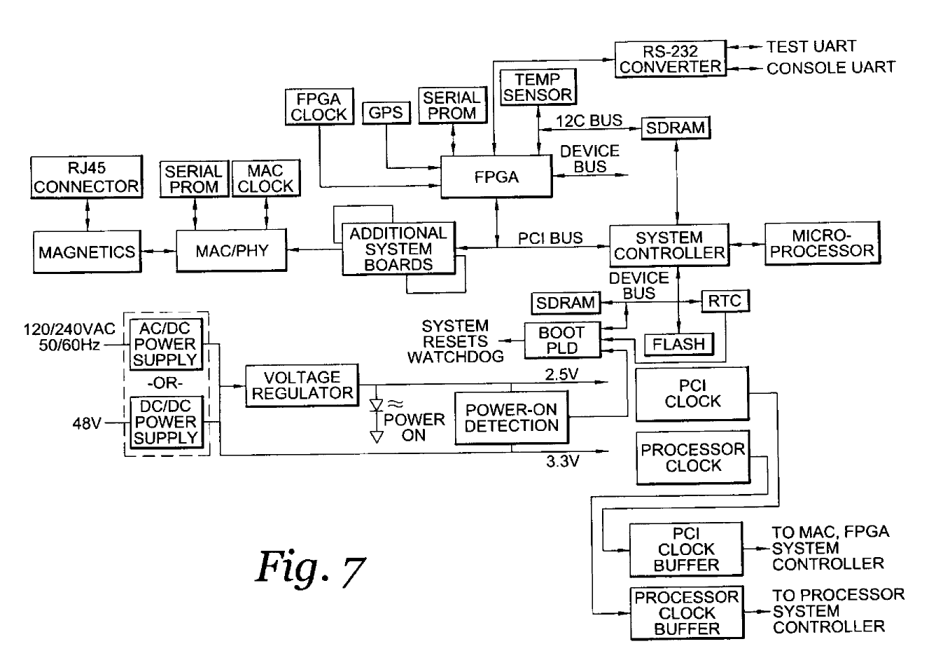

Referring now to FIGS. 6 and 7, schematics for the electrical components of the nodal members 30 are shown. Referring back to FIG. 1, the database 40 stores measurement data generated by the nodal network 20. The workstation 60 is connected to the database 40 via the application server 50, and provides a user interface for system configuration 92, including sending vector configuration information to the database 40. The workstation 60 also provides a user interface for reporting of the measurement data. The application server 50 interfaces between the database 40 and the workstation 60 for system configuration 92 and results display. Results display includes obtaining the results data from the database 40 and preparing the data for display. One or more service daemons 70 interfaces between the nodal network 20 and the database 40.

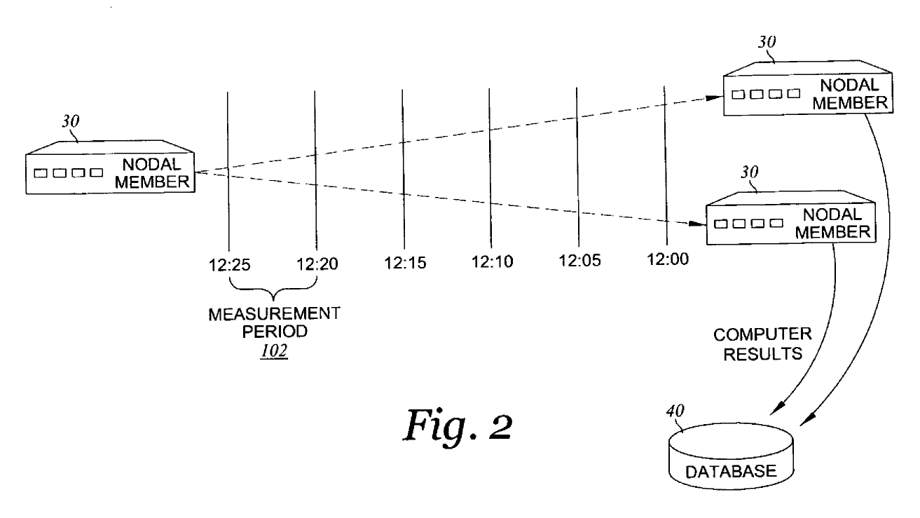

In one embodiment of the network metric system 10, measurements are accomplished by transmitting a Scalable Measurement Header (SMH) 230 within the measurement packets 200 between the nodal members 30 from the nodal network 20. It is also contemplated that SMH 230 may be transmitted between the nodal members 30 and the level 1 or level 3 cNode agents. In general, the time-based metrics are made with nanosecond resolution. Delay related one-way measurements are made with microsecond resolution when using a Global Positioning System (GPS) time synchronization system. Delay related round-trip measurements are made with nanosecond resolution. However, the round-trip measurements do not require time synchronization. In one embodiment of the present invention, results are calculated based upon a 5 minute measurement period 102 and are transmitted from the nodal member 30 to the database 40 for later analysis as shown in FIG. 2.

With reference to FIG. 3, a multi-protocol label switching (MPLS) VPN 104 is shown. The MPLS backbone network 104 includes a plurality of label switch routers 106 and the Service Provider (SP) edges 108. The nodal members 30 of the present invention may be located at the SP edges 108 of the MPLS network 104. This allows for Carrier Ethernet measurement of quality and functionality between the SP edges 108. However, end-to-end VPN measurement of quality and functionality may be more informative. For example, Customer A 110 may include two physical branches. The network between Customer A 110 and the SPs provider edge 108 is represented by a VPN A 114. VPN A also represents the local loop measurement 114. Therefore, an end-to-end measurement of the entire VPN network for customer A is represented by the network between the SP provider edges 108 and the two local loop measurements 114. Thus, to measure the quality and functionality of the entire VPN network, the nodal member 30 is added at the customer premise location 112. In another embodiment, the level 1 or level 3 cNode agents may be incorporated at the customer premise location 112 while maintaining the nodal member 30 at the SP provider edges. Furthermore, the level 1 or level 3 cNode agents may be incorporated at various points along the network.

In accordance with the present invention, a vector is used to describe a measurement case. The vector defines measurements from one nodal member 30 to another nodal member 30. Additionally, the vector defines measurements between one nodal member 30 and the level 1 or level 3 cNode agents. Each vector has a start point and an end point. The start point is the nodal member 30 that is transmitting the measurement packets 200 to the receiving nodal member 30, the latter of which is the end point. Hereinafter, the terms transmitter and receiver are considered equivalent to start point and end point nodal members 30, respectively. In another embodiment of the present invention, multiple vectors are created between a start point and an end point. The creation of multiple vectors between a start point and an end point results in the ability to measure multiple classes of services (CoS). This is advantageous because the multiple CoS may require unequal attention. The Ethernet supports multiple CoS including but not limited to HTTP, VoIP 96, Video, VPN, FTP, STP, and GARP. The ability to distinguish between the multiple CoS and measure the performance of a particular class is highly desirable. The creation of multiple vectors between nodal members 30 allows for measuring the performance of multiple CoS. Additionally, a vector handler computes and stores measurement results between the nodal members 30. For a one-way measurement between nodal members 30, the vector handler is located on the receiving nodal member 30. For round-trip measurements between the nodal members 30, the vector handler is located on the nodal member 30 that generated the measurement packet 200.

In another embodiment of the network metric system 10, the vector is the fundamental definition of the path and measurement traffic between two nodal members 30 or between one nodal member 30 and the level 1 or level 3 cNode agents for the calculation of various metrics at the Ethernet layer. As the fundamental measurement service element, a vector describes the path and measurement traffic type. It is uniquely defined by a measurement packet 200 between specific source and destination addresses. In one embodiment, a vector is defined by a source address, a destination address, and a service type with user-definable headers (Ethernet, LLC/SNAP, IP, TCP/UDP), CoS bits, DSCP, VLAN tags, payloads and packet size. This fundamental Ethernet layer metric allows for service-based, comparable measurements that translate cross-application and cross-platform. With this flexibility, customers can configure vectors to create high-fidelity measurements that exactly match their existing and/or planned Ethernet traffic.

Each vector has an associated set of characteristics. These characteristics include items such as packet size, payload type, header type (none/UDP/TCP), udp/tcp source and destination port numbers, DSCP/DiffSev bits, TTL value, IP protocol value, IP options, default gateway, source and destination MAC addresses, Ethernet type field, VLAN ID and Class of Service values (CoS), Link Layer Control (LLC)/Snap Headers and Parameters, and TCP header information. Further, a certain set of characteristics can be assigned a name such as ‘high priority’ or ‘best effort’. This makes it easy to reuse a particular set of characteristics.

In accordance with yet another embodiment of the network metric system 10, all measurements are made on the end point nodal member 30. It is the responsibility of the transmitter to send out measurement packets 200 to the receiver. It is also the responsibility of the transmitter to send out an ending packet 200 at the end of each measurement period 102. This ending packet 200 signals the receiver that all packets 200 in the measurement period 102 have been transmitted. Once the receiver acquires the ending packet 200 at the end of the measurement period 102, the receiver becomes responsible for gathering the data of all packets 200 received from the transmitter, calculating the results based on the data contained in the packets 200, and finally sending the results to the database 40 for storage.

In the network metric system 10 of the present invention, the Scalable Measurement Application Protocol (SMAP) service daemon 70 is the foundation of the scalable and reliable application server 50 architecture. In one embodiment, the service daemon 70 interfaces with the nodal members 30 and the database 40, instructs the nodal members 30 to create new vectors, obtain vector configuration information from the database 40, and handle results data transmitted from the nodal members 30 to the database 40. Initially, vector configuration information is sent from the workstation 60 through the application server 50 to the database 40. In some embodiments of the present invention, multiple service daemons 70 are run simultaneously to provide for system redundancy. If a service daemon 70 experiences a failure, the nodal members 30 continue to measure and store their results until a replacement daemon 70 is activated. In another aspect of the present invention it is contemplated that at least one nodal member 30 is set to stand-by in case another nodal member 30 fails for any reason. The nodal member 30 can automatically replace the failed nodal member 30.

In one aspect of the present invention, the service daemon 70 allows the network metric system 10 to be self-sustaining, with measurements performed, and results stored, without dependence upon the user interface. Further, the service daemon 70 allows the user interface to be changed or otherwise updated without affecting the underlying system architecture. Moreover, the service daemon 70 preferably allows the flexibility to potentially let third-party applications access the measurement system 10, as desired.

In an embodiment of the network metric system 10, the measurements performed by the nodal members 30 provide cross-application and cross-platform comparable measurements. As described above, the system utilizes a vector-based measurement system to achieve service-based, comparable measurements between the nodal members 30. Specifically, the vector-based measurement system defines a vector using a start point, an end point, and a CoS type.

A nodal member 30 can be configured to be the start point or end point of many vectors simultaneously. Note that the packet 200 sent out at the end of each measurement period 102 is not sent for each vector, but rather it is sent on a per nodal member 30 basis. For example, if one nodal member 30 is the transmitter of two vectors to the same receiving nodal member 30, the transmitting nodal member 30 only sends one packet 200 at the end of the measurement period 102, rather than two.

The nodal members 30 in the network metric system 10 of the present invention perform measurements and store measurement data over a set measurement period 102. As described above and shown in FIG. 2, the results are preferably calculated based on a 5 minute measurement period 102. However, any desired measurement period 102 may be used in other embodiments of the present invention. The results data for each measurement period 102 is sent from each nodal member 30 to the database 40 utilizing the SMAP protocol for later analysis. The SMAP Protocol is a communications protocol that is used for communication between nodal members 30 and the other elements of the network metric system 10. The results for each measurement period 102 are sent from each nodal member 30 to the service daemon(s) 70 and then onwards to the database 40 utilizing the SMAP protocol. Moreover, configuration data and status data are also sent via SMAP protocol. The SMAP protocol has the capability of using XML language.

The SMAP protocol is an efficient, secure, non-processor intensive, non-bandwidth intensive transfer protocol. Use of the SMAP protocol allows processor and bandwidth intensive protocols such as Simple Network Management Protocol (SNMP) to be avoided. The SMAP protocol is also used for communication between the nodal members 30. Moreover, the SMAP protocol can be expanded and modified, as needed, throughout the development life cycle of the product.

### Set of Metrics

The network metric system 10 of the present invention measures and reports a complete set of Ethernet metrics that are useful to network engineers for proper network design and configuration. The completeness of these Ethernet metrics provides significant advantages over prior measurement gathering systems. Specifically, the Ethernet metrics, in accordance with the present invention, preferably include, by way of example only, and not by way of limitation: Delay (minimum, maximum, average, standard deviation, percentile), Delay (MEF), Delay (untrimmed), Jitter/Delay Variation (minimum, maximum, average, standard deviation, percentile, Jitter/Delay Variation (untrimmed), Packet Loss, Availability, Outages (minimum, maximum, total, average length), Rate Ration, R-Factor (G.729, G.711), Transmit Bit Rate, Transmit Packet Rate, Receive Bit Rate (minimum, maximum, average, standard deviation, interval), Receive Packet Rate (minimum, maximum, average, standard deviation, interval), Packets Out-of-Order, Groups of Packets Out-of-Order, Sequential Packets Lost (minimum, maximum, average, standard deviation), Sequential Packets Dropped (minimum, maximum, average, standard deviation), Packets Dropped, Packets Duplicated (number duplicated, minimum, maximum, average), Packets Tagged (number tagged, copy of first tag, copy of last tag), Packets Untagged, VLAN ID (mismatches, changes), VLAN CoS (mismatches, changes), Destination Address (unicasts, multicasts, broadcasts, mismatches, changes), Source Address (mismatches, changes), Transmit Interface (speed, duplex, speed changed flag, duplex change flag), Receive Interface (speed, duplex, speed changed flag, duplex change flag), Packets with CRC Errors, Packets with Alignment Errors, Packets Too Short, Packets Too Long (Jabbers), Accumulative to Transmit Interface (good frames, collisions, excessive collisions), Accumulative to Receive Interface (CRC errors, alignment errors, resource errors, short frames), DSCP (changes, copy of first value, copy of last value), Packets Dropped Due to Missing Fragment, Packets Fragmented (number fragmented, minimum fragments, maximum fragments, average number fragments), L3 IP Header Corrupted (UDP/TCP), Hop Count (changes, minimum, maximum, average), L3 IP Protocol (mismatches, changes), Record/Strict/Loose Route Info (number record, copy of first set, copy of last set), Payload Corrupted, Measurement Header Corrupted, cNode Level 1 Agent (MAC address, invalid responses, flag if Level 1 results), Transmitting System Synchronization (status, changed flag), Receiving System Synchronization (status, changed flag), Packets (transmitted, received), Bytes (transmitted, received), Bursts received, Mismatched timestamps, Transmitting System (system type, version, minimum temperature, maximum temperature, average temperature) and Receiving System (system type, version, minimum temperature, maximum temperature, average temperature). Furthermore, many of these Ethernet metrics can be subdivided and described in further detail.

A code version number provides the version number of software operating in the nodal members 30, which is important when updates are made or are being planned. In source identities, the sending nodal member ID should be recorded as well as the sending vector ID. Regarding the sending nodal member ID, all the nodal members 30 have a hard-coded identity and can be named. With respect to the sending vector ID, a default identifier of all vectors is automatically created.

In the time parameter category, specific metrics include measurement period ID, nodal member measurement period ID, and universal time. The measurement period ID is defined as continuous time divided into periods identified by measurement ID. The nodal member measurement period ID relates to the measurement period of the nodal member 30 that is transmitting packets. The universal time metric provides an absolute time reference for all measurements.

Several Ethernet metrics relate to sequence, byte, and packet loss. These include sequences received, bytes received, bytes transmitted, packets received, and packets transmitted. Referring to the sequences received metric, when packets 200 are sent to multiple nodal members 30, each nodal member 30 receives a sequence of packets in turn. The number of sequences received is counted separately from the number of bytes and packets received. In order to measure sequential packet loss (the number of packets dropped in a row), it is necessary to be able to identify the sequence in which the packet 200 was sent. This should be indicated per measurement period 102. Packet loss is calculated as the number of packets transmitted minus the number of packets received. Packet loss does not take account of duplicate packets. The bytes received metric refers to the number of bytes received per measurement period 102. Bytes transmitted are defined as the number of bytes transmitted per each measurement period 102. Packets received are defined as the number of packets received per measurement period 102. Finally, packets transmitted are defined as the number of packets transmitted per measurement period 102. The out-of-order packets metrics category includes a measurement for packets out of order and groups out of order. Referring to the packets out of order measurement, nodal members 30 implement the sophisticated algorithm described above to calculate the number of packets that arrive out of order. Since such packets may be grouped together, the system 10 also applies the algorithm to groups of out-of-order packets to produce the group's out-of-order measurement.

Error packet types are a large category of Ethernet metrics. These include packets duplicated, minimum packets duplicated, maximum packets duplicated, packets dropped, packets dropped due to missing fragment, packets fragmented, minimum packets fragmented, maximum packets fragmented, average packets fragmented, IP packets corrupted, SMAP info packets corrupted, pay load packets corrupted, and optional header packets corrupted. The packets duplicated metric is produced by identifying duplicated packets and accounting for duplicated packets in the calculation of packet loss. The packets dropped metric identifies the packets transmitted and the number of which were dropped. This calculation takes account of duplicated packets. The packets dropped due to the missing fragment metric accounts for packets that were received but counted as dropped packets due to missing fragments. The packets fragmented metric is defined as the number of packets received that were fragmented. In the SMAP information packets corrupted metric, the nodal member 30 identifies corruption in the SMAP information field. In the payload packets corrupted metric, the nodal member 30 identifies corruption in the payload. Finally, in the optional header packet corrupted metric, the nodal member 30 identifies corruption in the optional header.

The sequential packet loss (loss patterns) category also preferably includes numerous sub-categories of desirable metrics. These include minimum sequential packets dropped, maximum sequential packets dropped, average sequential packets dropped, standard deviation of sequential packets dropped, minimum sequential packets lost, maximum sequential packets lost, average sequential packets lost, and standard deviation of sequential packets lost. All of these sequential packet loss pattern metrics are calculated using the number of packets dropped in immediate succession to each other. These calculations are performed for both lost and duplicated packets.

The packet hop count category of metrics preferably includes the sub-categories of packets TTL changes, packets TTL minimum, packets TTL maximum, and packets TTL average. For each of these packets TTL-based metrics, the measurements are calculated by using the hop count derived from the changes in the time-to-live field in the optional IP header of the packet. TTL (time to live) is a function that limits the life of a packet to a designated number of hops between the nodal members 30. The time-to-live function is useful in identifying the length of a path taken by a packet 200 between two nodal members 30, and is particularly useful with respect to packets 200 that move along asymmetrical paths.

In the network metric system 10 of the present invention, the Ethernet metrics being recorded also include packet IP protocol errors and packet IP protocol changes within the category of IP protocol tracking. Further Ethernet metrics being tracked include the category of packet type of service (DSCP) and differentiated services (DiffServ) changes. Subcategories of metrics within the packet DSCP and DiffServ changes category include the packets DSCP changes metric, in which the nodal members 30 record differences in the DSCP field, as well as the packets first ten DSCP count metric.

Still another Ethernet metrics category is packet jitter. Further metrics within this category include jitter minimum, jitter maximum, jitter average, jitter standard deviation, and jitter standard deviation power 4. The jitter standard deviation power 4 metric allows calculation of statistical accuracy from which minimum, maximum, and standard deviation for jitter are reported.

One-way latency is another general category of metrics under which several specific Ethernet metrics are preferably tracked. These include latency minimum, latency maximum, latency average, latency standard deviation, latency standard deviation power, and latency time stamp mismatch. The latency standard deviation power metric is used to allow calculation of statistical accuracy, from which the minimum, maximum, and standard deviation for jitter are reported.

Another Ethernet metric's category of outages in the network metric system 10 of the present invention includes the subcategories of outages, outage duration, minimum outages, outage duration maximum outages, and outage duration total outages. These subcategories of outage metrics are calculated by using a certain period measured in nanoseconds after which an outage counter is started if no packets 200 are received. The outage counter is stopped when the first new packet is received.

The final category of Ethernet metrics that is tracked by an embodiment of the network metric system 10 is that of route information. The system 10 records first and last packet information for all packets 200 of a measurement period 102 that have IP options set for record route, strict route, or loose routes. The record route function records the actual path taken by a packet 200 between two nodal members 30. The strict route function forces a packet 200 to take a specific path of travel between two nodal members 30. The loose route function allows the packet 200 to take any path as it is routed between the nodal members 30. The specific sub-categories of Ethernet metrics recorded within the route information category include first route type, first route count, first route packet ID, first route data, last route type, last route count, last route packet ID, and last route data.

### Vector Handler

The Vector Handler class is used to encapsulate all received packets 200 and result calculations for a single measurement period 102. It inherits from the Atomic Algorithms that contain all of the result calculation routines except for the Calculate Results routine.

### Calculate Results Method.

This method is called one minute after the measurement period 102 is over and the ending packet 200, indicating that all packets 200 have been sent, arrives from the transmitter. This method retrieves the packets 200 for a given measurement period 102. It then retrieves the non-unique 0 based period ID from the first packet 200 with a non-corrupted SMH header 230. After allocating the required memory to calculate the results, it calls additional methods to do most of the calculations (specifically the methods listed in the Atomic Algorithms section). This method then gathers the version information, temperature information, vector identification information, additional vector information, route information, and port counters and places them in the results structure. Finally, it calls a method to place the results into the hash tables for temporary storage before transmitting them out to the database 40 on another computer.

### Atomic Algorithms

This class contains all of the methods that are used by the Vector Handler, which inherits this class, to calculate results from the Atomic Packet Data linked lists for a measurement period 102. The methods contemplated include a Dolt function, a first pass method, a second pass method, a third pass method, complete duplicate, and DoRate. The Dolt function include the following parameters: last received time stamp estimate, packet wait time (in nanoseconds), measurement period, outage trigger (nanoseconds), outage cool count, packet size, delay offset and percentile, jitter percentile, and rate interval (nanoseconds). The Dolt function may be implemented as follows:

bool Dolt (pCQOSResults2 pResults, pATOMICPacketData pAtomic, DOCKVectorHandlerPreppedData *pData, uint64 txCount);

The first pass method loops through all of the Atomic Packet Data packets and places all packets 200 with non-corrupted SMH 230 in an information array. The first pass method may be implemented as follows:

static uint64 ProcessFirstPass(pCQOSResults2 results, pATOMICPacketData atomic, DOCKVectorHandlerPreppedData *pData, pPACKETRecordInfo *rInfo, uint64 *rCount, uint64 *maxSize, uchar *droppedList, uint64 *maxSize, uchar *droppedList, uint64 *latencyList, uint 64 latencyMEFConst, uint 64 latencyPercent, uint 64 *txCount, uint64 waitTime, int64 _rttDelayOffset);

The second pass method calculates duplicated packets, creates a transmission order list, and calculates jitter and outages. Additionally, numerous metric results are calculating during the second pass method. The second pass method may be implemented as follows:

static uint 64 ProcessSecondPass (pCQOSResults2 results, pPACKETRecordInfo rInfo, uint 32 *transmissionOrderList, uint64 rCount, uint32 *duplicatedList, uint16 *duplicatedCountedList, uint64 *duplicatedListSize, uint64 txPackets, uint64 rxPackets, uint64 outageTriggerTimeNS, uint64 mperiodNanoseconds, uint64 cnodeVerifyRxTimestamp, uint64 outageCoolCount, uint64 *jitterList, uint64 jPercent, uint64 *transmissionOrderListCnt, int64 _rttJitterOffset);

The third pass method calculates the received groups out of order and received packets out of order. The third pass method may be implemented as follows:

static uint64 ProcessThirdPass(pCQOSResults2 results, pPACKETRecordInfo rinfo,

uint64 rCount, uchar *marked, uint64 markedSize, uint32 *terminals, uint32 *retRuns);

The next function computes and updates outages. It may be computed as follows:

static void _ComputeAndUpdateOutages(pCQOSResults2 pResults, pPACKETRecordInfo pInfo, uint64 rCount, uint64 txPackets, uint64 rxPackets, uint64 mPeriodNanoseconds, uint64 outageTriggerTimeNS, uint64 outageCoolCount);

Finally, the DoRate function computes rate information for received packets. This is accomplished by looping through all received packets. It may be implemented as follows:

static void _DoRate(pCQOSResults2 pResults, pPACKETRecordInfo pRInfo, uint64 rinfoCount, int packetSize, uint64 ratelnternalNanoseconds, uint64 *rateList, uint64 *ratePacketList, uint64 rateRxPercent, uint64 rateTxPercent, uint32 *transmissionOrderList, uint64 transmis sionOrderListCnt);

### Measurement Packet

Referring now to FIG. 4, the measurement packet in accordance with the present invention, utilizes a specific, efficient packet format. This packet format includes all of the pertinent information required for the methodology of the network metric system 10 of the present invention. In one embodiment of the present invention, the packet format is configured as: Ethernet header 280, Optional IP Header 270, IP Header Options 260, Optional Header (UDP/TCP) 250, payload (zeroes/ones/random) 240, SMH 230 and Ethernet CRC 210. Preferably, CRC's 210 are calculated for payload 240, TCP/UDP header 250, and SMH header 230.

### SMH Packet Structure

Shown below is one format of a measurement packet 200. It consists of an Ethernet Header 280 and CRC 210, the payload 240, and a SMH 230. These items are briefly described in the sections that follow except for TCP/UDP headers 250. TCP/UDP headers 250 are not discussed because measurement of TCP/UDP packets 250 to application ports is not measured.

|Ethernet Header (14 bytes|
|LLC, SNAPT (Laser to Control Protocols (variably bytes)|
|Optional IP Header (20-80 bytes)|
|Payload (46-2000 bytes with IP, TCP/UDP, SMH)|
|SMH (42 bytes)|
|Ethernet CRC (4 bytes)|

### Ethernet Protocol and Header Information

The Ethernet protocol is the protocol actually used to physically transport packets 200 to and from the nodal members 30, and to and from the router connected to the nodal members 30. The format of an Ethernet packet is shown below.

|Ethernet destination address (first 32 bits)|
|Ethernet destination address (last 16 bits)| Ethernet source address (first 16 bits)|
|Ethernet source address (last 32 bits)|
|Type code (16 bits)|
|Payload (368-12000 bits)|
|Ethernet CRC (32 bits)|

The Ethernet destination address is a 48 bit unique identifier of the Ethernet controller to receive the packet 200. The Ethernet source address is a 48 bit unique identifier of the Ethernet controller transmitting the packet 200. The payload 240 is the portion where TCP/UDP 250 and SMH 230 information resides. It also is the portion where any other data sent is contained. The maximum size of the payload 240 section is 12000 bits which defines the maximum size of data that can be sent per packet 200. The Ethernet CRC 210 is a 32-bit value that is used to validate the contents of the entire Ethernet packet 200. It is also contemplated that the Ethernet CRC 210 may implement Message-Digest algorithm 5 (MD5). MD5 is a widely used cryptographic hash function. It is used to determine the integrity of files.

### IP Protocol and Header Information

The IP protocol is used to transport packets 200 across the Internet regardless of the actual connection protocols between routers. This protocol lies at the heart of the Internet and its header fields contain information that is saved in the results. The version field contains the current version of IP (normally 4). The IHL field contains the length of the header in 32 bit words. This is normally 5 except when an IP optional header 270 is used in which case it can be up to 15 (Verify IP optional header size). The DSCP field contains priority information that may or may not be used by routers to give packets 200 higher or lower priority. The Total Length field specifies the total length of the packet 200 (excluding the Ethernet header and CRC) in bytes. The Identification field is used to identify the packet 200. The Flags field (3 bits) is used in fragmentation. The first bit, if set, signifies that routers should not fragment the packet 200. If a router must fragment a packet 200 and the first bit is set, the router will drop the packet 200. The last bit, if set, signifies that there are more packets 200 after this packet 200 that were originally part of one packet 200 but were fragmented into smaller ones. The Fragment Offset (13 bits) is the offset from the previous beginning of the original packet 200 if it is fragmented into smaller pieces. It is in units of 8 bytes. The Time to Live (TTL) field indicates the maximum number of hops that this packet 200 can take before reaching the receiver or the packet is dropped 200. The Protocol field indicates the transport protocol used (ICMP=1, IGMP=2, TCP=6, UDP=17). The Header CRC 210 is used to validate the contents of the IP header 260. To calculate the CRC 210, all fields in the IP header 260 (except for this field are ignored) are treated as 16-bit numbers and complemented. Then all are summed and stored here. Upon receiving the packet 200 all are summed and if all 1's then the header is not considered corrupt. The Source Address contains the IP address of the transmitting host. The Destination Address contains the IP address of the receiving host.

### SMH Protocol and Header Information

The SMH 230 is contained at the end of the Ethernet payload 240. This header contains original values of data that can be changed during transmission of a packet 200. It is located by subtracting the size of the SMH (42 bytes) 230 from the end of the payload section 240. If the packet is corrupted, the SMH 230 can also be found because the first field is 64-bit ASCII field that contains SMH.

|Tag Info A (32 bits)|
|Tag Info B (32 bits)|
|Short ID=(16 bits)| Payload CRC A (16 bits)|
|Payload CRC B (8 bits)| Scalable Measurement Header CRC (24 bits)|
|Period ID (32 bits)|
|Burst ID (32 bits)|
|Packet ID (16 bits)| Time Stamp A (16 bits)|
|Time Stamp B (32 bits)|
|Time Stamp C (16 bits)| Not Time Stamp A (16 bits)|
|Not Time Stamp B (32 bits)|
|Not Time Stamp C (32 bits)|

The Tag Info field contains the identifier of the beginning of the SMH 230 which consists of the ASCII SMH value and is used to find the header if the parts of the packet are corrupted. The Payload CRC field contains a CRC for the entire payload 240. The SMH CRC field contains a CRC for the SMH 230.

The Period ID field contains the unique ID of the period for the nodal members 30. The Vector ID contains the ID of the vector. The Period ID contains the 0 based ID of the measurement period 102. The Burst ID contains the identifier of the burst that the packet 200 is in. The Packet ID contains the identifier of this packet 200 (sequence number). The Tx Time stamp contains the time stamp of the packet 200 when it was transmitted. The Not Tx Time stamp field contains the inverse of the Tx Timestamp field so that the field can be verified even if other parts of the header are corrupted.

### Nodal Member Hardware

In one embodiment of the present invention, the nodal member 30 contains on-board intelligence, multiple on-board processors, 64-bit counters, full Internet-working functionality, Ethernet ports, a rack-mountable configuration, dual modes of type synchronization, one gigabyte of SDRAM, 64 MB of Flash RAM, internal GPS, external time synchronization ports, dual power supply, 12.5 nanosecond packet time-stamping, storage of up to 36 hours of measurement results, internetworking compliant and intelligent upgrading. In another embodiment, each nodal member 30 has two 10/100 MBPS Ethernet ports. Preferably, one port is used for measurement traffic and in-band management traffic. The second port may optionally be used for out-of-band management. This configuration provides the benefit of allowing management traffic to run on a separate management network.

In the network metric system 10 of the present invention, the nodal members 30 are designed with feature expansion in mind, and with room for additional measurement network interfaces. An aspect of the invention contemplates the nodal members 30 being rack-mountable devices that include two U-boxes with front panel LEDs, an IrDA port, and a serial port. Preferably, a command line interface is also accessible through the serial port, IrDA port, or Telnet. This rack-mountable configuration provides desirable space efficiency. Further, the IrDA port eliminates the requirement for a serial cable for basic configuration and diagnostics. This also allows CE devices and palm pilot devices to be used for configuration.

There are two main components that comprise the nodal member 30, Component 1, and Component 2. Each component is responsible for different tasks and has different connected interfaces. Component 1 contains the time stamping hardware, an Ethernet controller, and a microprocessor. It connects to the auxiliary serial port at the back of the box, the GPS connector, the PPS signal, the Ethernet Measurement port, and Component 2. Component 1's main responsibility is to transmit and receive packets 200. During transmission or reception of packets 200, Component 1 places a very accurate time stamp 220 in the packet 200 (as described below). Packets 200 received are sent to Component 2 for further processing.

Component 2 contains an Ethernet controller and a microprocessor. It connects to the serial port at the front of the box, the PPS signal, the IrDA interface, the Ethernet Auxiliary port, and Component 1. Component 2's responsibility is to keep track and store vectors and their respective packets 200, calculate results at the end of measurement periods 102, and handle any high level protocols. The results previously mentioned are calculated on Component 2, including layer 2 calculations. All the classes and methods described below are contained in Component 2.

### Time Stamping

In accordance with the present invention, the nodal members 30 implement hardware time stamping. The hardware time stamp 220 is received on the packet 200 and travels with the packet 200. The time stamp 220 may be used to make accurate round-trip time measurements or one-way time measurements. Hardware time stamping 220 is more accurate than software time stamping. Additionally, the hardware time stamping 220 offloads the processor-intensive activity of time stamping to free up processing power. Preferably, the time stamp 220 is applied to the output buffer after the header information and data information fill the output buffer, so as to more closely represent the time at which the measurement packet 200 is actually transmitted. Using this technique, the time stamp 220 is generated very close to the actual transmit time, such that any remaining delay between the time request and the application of the time stamp 220, or the transmission of the packet 200, is discernable with substantial accuracy to permit advancing the time stamp 220 to actual transmission time. As a result, the latency time, as measured by receiving input to the receiving nodal member 30, is substantially devoid of inaccuracy due to processing times and processing variations in the transmitting nodal member 30.

Because the time stamp 220 is generated a short period before it is applied to the packet 200 and the packet 200 is output, the delay between generation of the time stamp 220 and application or packet output, is predictable with substantial accuracy. Unlike conventional systems, the time stamp 220 is not generated before the output buffer begins to fill, and therefore, is not subject to processing delays and irregularities that precede filling the output buffer. Consequently, the time stamp 220 generated can be advanced by a predictable time increment such that the time stamp 220 actually correlates to the time at which the time stamp 220 is applied to the packet 200, or when the packet 200 is output to the service provider (SP) transmission path. This allows application of a time stamp 220 that is initiated at the time at which the packet 200 is formed, or transmitted, not an earlier time.

In an embodiment of the network metric system 10, the receiving nodal member 30 similarly generates a time stamp 220 as the packet fills the input buffer, rather than after the packet 200 is further processed. As such, the receive time stamp is offsetable by a predictable time delay to correlate to the time at which the packet 200 is actually received at the receiving nodal member 30. One-way signal latency may, therefore, be accurately determined with a minimum of corruption due to variable internal processing within the sending and receiving nodal members 30. It is contemplated that the transmit (Tx) hardware time stamp 220 is stored within the measure packet 200. In particular, the Tx time stamp 220 is stored as part of the SMH 230. Additionally, the receiving (Rx) hardware time stamp 220 may be stored on the receiving nodal member 30.

### Node Processing

In another embodiment of the network metric system 10 of the present invention, each nodal member 30 includes sufficient onboard intelligence to perform processing of the measurement data for each measurement period 102. This is achieved by implementing a complex algorithm and compressing the results, preferably to one kilobyte per five minute measurement period 102 per vector. This distribution of intelligence to each nodal member 30 allows the system to eliminate centralized processing of the raw data. Further, this onboard intelligence and processing ability of the nodal member 30 minimizes the results traffic on the network, thus, increasing scalability as a result of this distributed processing. Moreover, this system architecture eliminates the problem of single-point failure. Each nodal member 30 may store up to 48 hours of vector information in a circular buffer. If the receiving nodal member 30 does not receive a packet 200 signaling the end of a vector measurement period 102 within that period, the vector information for that period is considered invalid and is discarded.

An aspect of the present invention contemplates the nodal network 30 of the network metric system 10 utilizing multiple on-board processors. This allows one processor to handle management processes, while another processor handles measurement processes. This configuration also has the benefit of increasing scalability of the system. Further, the nodal member 30 of the present invention utilizes counters with exclusively 64-bit values. This allows wrapping of the counters to be avoided.

In one embodiment of the network metric system 10, the nodal members 30 are true Internet working devices, which are capable of supporting TCP/IP, SNMP, Telnet, TFTP, dhcp, BootP, RARP, DNS Resolver, Trace Route, and PING. The nodal members 30 are high-quality devices that Service Providers can confidently deploy and manage within their own systems.

The nodal members 30 in the network metric system 10 of the present invention have synchronized timing systems. In this regard, the nodal members 30 preferably support network time protocol (NTP). An embodiment of the present invention supports synchronization to multiple NTP servers. This synchronization is used in the calculation of one-way latency and jitter measurements. The one-way latency measurements provide insight into the asymmetric behavior of networks, and add a dimension of understanding of the performance of real-time applications (voice and multimedia). Another embodiment of the present invention also supports global positioning system (GPS) time synchronization, however, the system avoids dependence solely on GPS which can sometimes be difficult to support.

Advantageously, the nodal members 30 of the present invention are preferably capable of intelligent upgrading. In this regard, the upgrading of the nodal member 30 is automated, and as such, facilitates extreme scalability up to very large numbers of deployed nodal members 30, while maintaining minimal loss of measurement time. This ability greatly enhances ease of upgrading large deployments. Moreover, after download, new images are booted on all nodal members 30 in a synchronized fashion.

In one embodiment of the network metric system 10 constructed in accordance with the present invention, the system 10 implements several redundant features in order to account for any occasional failures or errors in the system. The nodal members 30 are equipped with a substantial amount of memory storage capacity (typically as RAM) and store results data for a period of time after the results have been sent to the database 40. If a results packet is lost in the transmission, the service daemon 70 senses this loss and implements the necessary procedures to retrieve the results. This type of automated error recovery allows for the network metric system 10 of the present invention to act as a carrier class, long-term, unattended system deployment.

In yet another embodiment of the network metric system 10, each nodal member 30 employs dual power supplies in order to provide for a backup power source in the case of a power supply failure. Moreover, in accordance with the autonomous nature of the nodal members 30, if a transmitting nodal member 30 is restarted for any reason, the nodal member 30 automatically goes through a Readiness Test and a Go/No-Go Test (described below), followed by the automatic resumption of measurements without any required user intervention. Correspondingly, if a receiving nodal member 30 is restarted and loses its vector handlers, then the nodal member 30 automatically sends a message back to the transmitting nodal member 30 indicating that the receiving nodal member 30 does not have a vector handler for the packets 200 that the transmitting nodal member 30 is sending. The transmitting nodal member 30 then goes through its tests, and normal operation is resumed. Advantageously, during such temporary outages as described above, the time periods for which there is no data are correctly accounted for as downtime for the nodal member 30, and not lost measurement packets 200.

### Readiness Test

As described above, in one embodiment of the present invention, each transmitting nodal member 30 insures the readiness of the receiving nodal member 30 before the transmitting nodal member 30 begins to send measurement traffic to another receiving nodal member 30 by performing a Readiness Test. This Readiness Test verifies linkage and reachability between the nodal members 30 before a test is run, without overburdening the network with unnecessary duplication of effort. Specifically, in one embodiment of the network metric system 10, the transmitting nodal member 30 performs a two-step Readiness Test upon creation of a new vector by the service daemon 70, or after a restart or other anomaly. These steps include: (1) pinging the destination nodal member 30; and (2) performing a Go/No-Go Test using the SMAP protocol.

In accordance with the present invention, the Go/No-Go Test provides protection from unwanted or unauthorized measurements being made on the nodal member 30 within the system, as well as providing protection from having the nodal member 30 measurement traffic accidentally sent to a non-nodal member. Additionally, the network metric system 10 preferably also employs password protection in order to limit access as desired (e.g., access to management applications). The nodal member 30 passes additional information to another nodal member 30 such as measurement and configuration parameters. The nodal member 30 also passes a shared secret to the other nodal member 30 for enhanced security.

### DSCP and CoS Bits (802.1q)

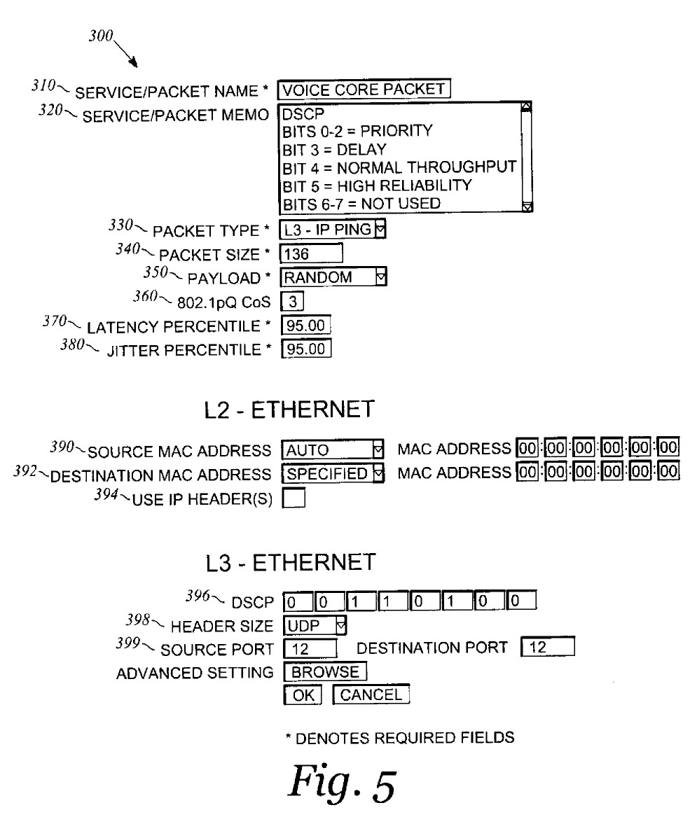

Referring now to FIG. 5, an embodiment of the present invention also contemplates allowing users to define the multiple CoS types 300 to be measured between the nodal members 30. For example, a user is able to specify the service/packet name 310 such as a voice core packet. The user may also set the priority of the service/packet memo 320. Further, the user may select the packet type 396, the packet size 340, the payload (zeroes, ones, and random) 350, 802.1 pQ CoS 360, latency percentile 370, and jitter percentile 380. Furthermore, the user may control settings of the Ethernet layer including the source MAC address 390 and the destination MAC address 392. An aspect of the present invention contemplates the option to check off or select the use of IP Header(s) 394. Additionally, the user may specify the bit value for DSCP 396, Header Type 398, and source port and destination port 399 for the level three internet protocol layer. This type of quality of service specific behavioral information is then readily available in the system reports. Further, the workstations 50 and embodiments of the present invention also allow vectors to be disabled without being deleted from the database 40. This provides the advantage of saving a user from having to redefine a previously defined vector.

Certain networks support different priority levels for the routing of network traffic. These policies can be based on the DSCP field settings 396 in a packet or they can also be based on other parameters such as the CoS bits, source address, packet contents, port number, or other header information. DSCP field 396 or differential services settings indicate data delivery priority. This priority may or may not be ignored by the routers in the path to the receiving nodal member 30. Some routers may actually replace these settings with different ones. The DSCP field 396 may be controlled by the CoS bits of the Ethernet packet 200.

For example, a router supports two policies, ‘high priority’ and ‘best effort’, with the default being best effort. The router knows by a packet's DSCP field settings 396 if the packet 200 is a default best effort packet or a high priority packet 200. The router then schedules the packets 200 transmitted based on the policy. For example, the router reserves 25% of the sending bandwidth for high priority packets 200 and the rest of the transmitting bandwidth for best effort packets 200. Because DSCP fields 396 and other parameters that affect QoS 94 can be modified it is possible to measure the different QoS policies and their effects. The DSCP field 396 has the ability to control CoS bits for Carrier Ethernet.

### Measurement Sequence

In a typical system 10, packets are sent one at a time in a round robin fashion. In order to measure jitter, a minimum of 2 packets from a single vector must be transmitted in order with no other packets 200 transmitted in between. The number of packets 200 that are transmitted one after another in a vector is called the measurement sequence. This is also known as a burst. For example, two vectors (A & B) with a default burst size of 1 will result in the transmission of a first packet from vector A and then a first packet from vector B. Likewise, if the burst size is 5, vector A will transmit five packets before alternating and vector B transmits five packets. A measurement sequence size of one is equivalent to the normal round robin transmission scheme. This can be used if jitter calculations are not desired. However, the round robin transmission scheme may not be desired because it may impede measurement traffic. A measurement sequence can be defined by selecting a particular vector and transmitting its burst, then selecting a new vector and transmitting its burst. The sequence may repeat in a different order. This results in a random distribution of measurement traffic.

This embodiment of the present invention utilizes a random measurement sequence. When multiple vectors are defined per nodal member 30, the measurement packets 200 are transmitted in complete blocks or may be interspersed with packets 200 for other vectors. This guarantees accurate jitter measurements in the presence of multiple vectors.

### Bandwidth Allocation

Another advantageous feature of the network metric system 10 of the present invention is its ability to provide user-definable measurement bandwidth allocation. This allows service providers that do not have a large amount of bandwidth available for measurement traffic to still be able to utilize the network metric system 10 of the present invention. In one embodiment, the vector rates are automatically adjusted in order to utilize only a predetermined amount of bandwidth. Once the user decides upon the amount of bandwidth to be allocated for measurement traffic, each nodal member 30 in the network metric system 10 automatically calculates the rate at which measurement packets 200 are generated based on the number of vectors, packet size, and the bandwidth allocated.

Test bandwidth is the rate at which packets 200 for a vector are transmitted. Transmitted packets 200 are not sent out all at once at the beginning of the measurement period 102. Instead packets 200 are transmitted out, based on measurement sequence, evenly spaced throughout the measurement period 102. The maximum test bandwidth depends on certain factors: maximum bandwidth of the network; the number of vectors at work on the nodal members 30; the number of packets 200 per measurement period 102 per vector; the packet size per vector; the measurement period 102.

The number of packets 200 transmitted in a measurement period 102 is definable per vector. The minimum number of packets 200 is one. The maximum number of packets 200 transmitted per vector is dependant upon: the test bandwidth; the number of vectors at work on the nodal members 30; the number of packets 200 per measurement period 102 per vector; the packet size per vector; the measurement period 102.

Packet Size and Payload

Packet size is dependent upon the size of the Ethernet header 280, Ethernet CRC value 210, optional IP header 270, SMH 230 and payload 240. The Ethernet header 280, Ethernet CRC value 210, and SMH 230 are always the same size and this is the minimum size of a measurement packet 200. The maximum packet size is currently defined as the maximum size of an Ethernet packet 200. This size is currently equal to 2000 bytes total including the header 280. This size was chosen in order to try and eliminate further packet fragmentation by routers. This may be changed in the future.

The size of the payload 240 can be changed and is what determines the size of the packet 200. The minimum size of the payload is 0. The maximum size of the payload is: Maximum packet size minus Ethernet header size minus Ethernet CRC value size minus Optional IP header size minus TCP/UDP header size (if used) minus SMH header size.

The contents of the payload 240 can be specified as being filled with random numbers, all 0's, or all 1's. The random numbers for each packet 200 are truly randomized and are not generated once for all packets transmitted.

### HDEFAULTS

HDEFAULTS are the default values given for vector characteristics. Packet information HDEFAULTS are automatically chosen to populate the packet 200 when configuring a vector. Values of this type include the contents of the SMH header 230. These values also specify the payload contents 240 of the packet 200.

Control information HDEFAULTS initially set the defaults for information regarding measurement sequence, test bandwidth, and any other information external to the measurement packets 200 themselves. Preferably, users can modify these characteristics, if needed, to other valid values. HDEFAULTS and specific vector characteristics can be retrieved from the nodal members 30. This makes it possible to fill in the HDEFAULT values through an application before setting up a vector on the nodal member 30. In an aspect of the present invention, the HDEFAULTS cannot be changed to other values.

Switches, Routers, or Other Transport Devices within Provider Networks

In modern routers there are two paths that can be taken when handling a packet, a slow path and a fast path. The slow path is taken if a packet 200 requires special handling that cannot be handled directly by the hardware. In this case, the processor on the router must be involved to handle the packet 200. Conversely, the fast path is taken if a packet 200 does not require special handling and does not have to be sent to the processor for handling.

Events that can cause the packet to take the slow path include: CoS field settings that the router needs to modify; a packet size that is too large to be sent out without fragmentation; and a packet 200 with an optional IP header 270 wanting record route or other routing information that must be extracted from the header. A side effect of this route path issue is that a packet 200 can be retransmitted with greater delay then packets 200 that take the fast path. If this delay is long enough, this can cause packets 200 to be received in the incorrect order, even if the packets 200 are sent to the same router.

The number of routers, switches, NIDs, or other networking devices between the transmitter and receiver, called hops, can have an effect on certain results. As the number of hops increases, the chance of an increase in latency, jitter, and lost packets also increases. Latency and jitter may increase just because of the nature of receiving and re-transmission. Lost packets may increase because the packet 200 must go through a greater number of queues where most packets 200 are dropped.

### Database

The database portion 40 of the present invention, in one embodiment is SQL compliant. In another embodiment, the database 40 is an Oracle database that manages vector configuration information and all results. The raw data is stored and available for a variety of reports. Advantageously, since the reports are not pre-created, but rather are pulled directly from the database 40, based on user-defined parameters, the reports are flexible and reflect true averages for the time periods chosen. The averages can be considered true because they are not averages of averages, as commonly and mistakenly calculated by prior art measurement systems. A database 40 of the present invention stores the original numerator and denominator data so that true averages can be calculated based on the user-defined parameters. The database 40 stores a full range of the complete set of Ethernet metrics that are described in detail below. Other data fields may also be added to the database 40 in other embodiments as desired. In one embodiment, the network metric system 10 manages all aspects of the database 40. However, in other embodiments, the system also supports unique data access requirements and customized application integration via the database 40.

In yet another embodiment of the present invention, the database 40 provides the vector configuration information to the service daemon 70, as well as storing measurement data transmitted from the nodal members 30 via the service daemon 70. The database 40 obtains the vector configuration information from the user interface of the workstation 60 via the application server 50. The application server 50 operatively connects the database 40 and the workstation 60 for system configuration and results display. Results display includes obtaining the results data from the database 40 and preparing the data for display.

### Workstation

Referring now to the workstation portion 60 of the network metric system 10 of the present invention, a browser based interface is utilized which allows SMAP management and reporting functions to be accessible from a simple web browser 80. In one embodiment the workstation 60 provides a user interface with the database 40 through the application server 50 for system configuration. System configuration includes creating and sending vector configuration information 92 to the database 40. In another embodiment of the present invention, the application server 50 is removed, and the workstation 60 interfaces with the service daemon 70. (In this embodiment, the functions of the application server 50 are performed by service daemon 70). An aspect of the present invention contemplates the application server 50 and database 40 providing load balancing. Additionally, the database 40 and application server 50 can be made redundant. Thus, it is contemplated that the system may function with or without the application server 50 or the database 40.

The network metric system 10 provides easy access to reports and management in the system from any computer without requiring special or complicated software installation. Preferably, the workstation 60 implements multiple secured access levels. Initial security levels include an administrator level and a user level. Preferably, the administrator has access to system configuration, which includes creation/modification/deletion of the nodal members 30, vectors, service types, logical groupings of vectors, and the user access list. These functions are easily accessible to the administrator from the home page of the browser-based user interface. Typically, a user can only view reports. These multiple access levels allow a greater level of security to be implemented into the system 10. In an embodiment of the network metric system 10, the user interface is secured using the Secure Socket Layer (SSL) protocol and the application server 50 also authenticates user connections. An aspect of the present invention contemplates accessing the system remotely using an application programming interface (API).

In one embodiment of the network metric system 10, the workstation 60 utilizes a traffic engineering application 98 as an operations and analysis tool that provides a user interface to the network metric system 10. The primary function of the application server 50 is to provide meaningful presentation of network performance measurements in order to allow network planners to view real-time, large-scale, scientific measurement of the Quality of Service performance delivered by their Ethernet networks.

In one embodiment to the present invention, the workstation 60 is utilized to implement user-definable groupings of vectors. Vectors can be logically grouped for ease of vector display and reporting. Useful groupings of vectors may include geographical, customer, network type, or priority based groupings. Additionally, groupings can also overlap (i.e., a vector can be part of several different groups). This configuration allows for ease of use and customizable reporting to suit various reporting needs and users. In some embodiments of the present invention, secure access may be available on a per-group basis.

### Alarms

An embodiment of the network metric system 10 provides customized alarms 90 for automatic triggering and notification of emerging performance issues, including integration into Network Management Systems (NMS) to enhance a customer's own network operations facilities. User alerts may be viewed through the user interface and may activate notification functions such as e-mail, paging, or transmission of SNMP traps for integration with established Network Management Systems (NMS) like HP OpenView.

Furthermore, the alarm capability of the network metric system 10 offers a tangible method of dealing with Service Level Agreement (SLA) 100 compliance. Through the use of several levels of alarm severity, set to trigger at thresholds progressively closer to the violation of a SLA 100, a Service Provider may proactively manage their service level agreements 100 for exactly the conditions that cause non-compliance (e.g., delay or outages).

The alarm 90 capability and general measurement capability of the present invention allows grouping of measurement vectors to give additional SLA benefits. Groups create a method of applying hierarchies to measurement solutions. Through the use of groups, a customer may separate the measurement of their Ethernet network in many ways, while only applying the measurement solution once.

### Reports

In one embodiment of the network metric system 10 of the present invention, basic real-time reports are automatically generated (without any additional configuration) that show one-way delay, round-trip delay, jitter, packet loss and availability measurements. These results are preferably presented in a side-by-side graphical and tabular display, with a separate line for each service type. True averages are provided for each time period, and a minimum, maximum, and standard deviation are also automatically shown. The present invention produces results using numerator and denominator values, so that true averages can be calculated through a sum of all numerators and a sum of all denominators. This avoids the smoothing effect created by calculating an average of averages.

An embodiment of the present invention provides a wide array of reporting options. The system allows a user to designate continuous time or time period history reporting, measurement period 102, start time, end time, and bi- or uni-directional measurements. This type of flexible reporting with customizable time periods up to and including the current period is highly advantageous to a system user. The network metric system 10 of the present invention preferably provides click through access to results that are not available from prior measurement products or services.

### General Algorithm Description

In one embodiment of the network metric system 10, after a vector has been configured on the transmitting nodal member 30, and the receiving nodal member 30 has initialized a vector handler, the receiving nodal member 30 is ready to receive measurement packets 200. Preferably, a linked list is created for each vector, for each measurement period 102. Measurement packets 200 received from another nodal member 30 are stored in this linked list in the order received. Packets 200 are stored in an atomic data unit structure. Hereinafter, measurement packets 200 and atomic data units are considered equivalent. An aspect of the present invention contemplates that after the measurement period 102 is over, 1 minute is given for any straggling packets 200 to arrive. When the vector receives the ending measurement period packet 200, the result calculation routines are called. In one embodiment of the present invention, if the end of measurement period packet 200 is not received within 48 hours, the results are discarded.

In one embodiment of the network metric system 10, the calculation methods take the packets 200 received and fills out the results. The results are then sent to another computer for subsequent analysis. The memory associated with the vector's current measurement period 102 is then freed. The following sections describe elements of the algorithm in more detail.

### Identification

In an embodiment of the present invention, as each packet 200 is received, the packet 200 is inserted into the appropriate linked list based on identification information contained in the SMH 230. This identification information is made up of four fields, the sending nodal member ID, the sending Vector ID, the measurement Period ID; and the nodal member Measurement Period ID.

The sending nodal member ID is a unique identifier that is given to each nodal member 30. The sending Vector ID is the vector identifier that is unique per sending nodal member 30. The measurement Period ID is an identifier starting from 0 assigned to each measurement period 102. The nodal member Measurement Period ID is also an identifier assigned to each measurement period 102, but if differs from the measurement Period ID in that it is unique and not 0 based. Based on 3 of the 4 identifiers that is, sending nodal member ID, sending Vector ID, and nodal member 30 Measurement Period ID, a guaranteed unique linked list is located to place the incoming packets into.

### Sorting

In one embodiment of the network metric system 10, it is possible that packets 200 are received in a different order from which they were transmitted. This usually indicates that some packets 200 took different routes than others. This can also happen if certain packets 200 require special handling that causes some packets 200 to take a slower path instead of the fast path on a router or some other device. In any case, the packets 200 received must be sorted into their original transmitted order because of jitter calculation requirements. Three special cases need to be dealt with when sorting: duplication, dropped packets, and fragmentation.

### Duplicates

Duplicate packets can occur because of various reasons. Duplicate packets are taken into account for most result calculations, except for jitter, outages, and ordering. In these cases, only the first occurrence is used. In order to detect duplicates, the list is traversed and all other items in the list are compared with the current item. If the sequence number of the item and the transmitted timestamp 220 match, then there is a duplicate. The index of the item is placed in an array allocated to store duplicate indexes. The current item is then incremented to the next one until all items in the list have been checked. Note that all items are placed in the duplicate array, even the first occurrence thereof.

Further along in the algorithm, the total number of duplicates, minimum number of duplicates for one item, and maximum number of duplicates for one item are all calculated based on the duplicate array. These are stored in the results as packetsDuplicated, packetsDuplicatedMin, and packetsDuplicatedMax. Eventually, an extra metric may be added that counts duplicates that took a different route from one another using TTL value comparisons.

### Dropped Packets

A packet 200 is dropped when a packet 200 is transmitted, but is not received.

The number of packets 200 transmitted are sent along with the special packet at the end of the measurement period 102. By counting the number of packets 200 in the linked list, the number of packets 200 received is known. When sorting the packets 200, a list of duplicate packets is built up so that the number of duplicate packets is known. With this information, the formula can be applied and the results saved in the packetsDropped field.

### Fragmentation

Fragmentation occurs in routers, switches, or other networking devices when a packet 200 arrives that cannot be sent out on the next route without breaking the packet 200 up into smaller pieces. This typically occurs because the next part of the route uses a protocol that has a maximum packet size that is smaller than the size of the current packet. Currently, the maximum size of the packet 200 is set to the maximum size of an Ethernet packet (2000 bytes). To calculate the fragmentation results, a loop is used to retrieve the proper results from all of the atomic packet data.

In accordance with the present invention, packetsFragmented is the sum of all the packets 200 that were fragmented and packetsFragmentedMin, packetsFragmentedMax, packetsFragmentedAverageNumerator, packetsFragmentedAverageDenominator are the minimum, maximum, and average fragmented packets respectively.

### Hop Count (TTL)

Hop count or Time to Live (TTL) is the maximum number of routers that can be traversed when transmitting data. Each time a packet 200 is retransmitted by a router, the TTL value is reduced by one. A router that receives a packet with a TTL value of 0 drops the packet 200. The transmitting nodal member 30 saves the original TTL value in the SMH 230 so that when the packet 200 arrives the hop count can be calculated. The HDEFAULT value of TTL is the maximum, 255.

To calculate the TTL results, a loop is used to retrieve the proper results from all of the atomic packet data. The current packet's TTL value is temporarily stored so that if the TTL field is different for the next packet 200, the number of changes can be saved. This indicates that the packet 200 took a different route than the previous packet 200.
In the present invention, packetsTtlMin, packetsTtlMax, packetsAverageNumerator and packetsAverageDenominator are the minimum, maximum, and average TTL values. packetsTtlChanges is the number of changes of TTL values between all of the packets 200.

### Jitter

Jitter is the difference between the time a packet 200 is expected to arrive, and the time it actually arrives. In other words, a measurement sequence of packets 200 is transmitted one second apart. Jitter is how far apart the packets 200 actually arrived.

To measure jitter, a measurement sequence greater than one must be transmitted and received. In addition, the received list of packets 200 must be sorted into transmitted order before calculating jitter. To calculate jitter the packets 200 are traversed in transmitted (sorted) order. For each measurement sequence, the first packet 200 in the measurement sequence is used as a base. The remaining packets 200 in the measurement sequence use the previous packet's received and transmitted timestamps 220 and subtract them from their own to calculate the jitter.

Dropped packets are not counted in jitter calculations. For example, if a burst of 5 packets comes in and packet 3 is dropped, the transmitted sequence of packets that were actually received is: 1, 2, 4, 5. The jitter between packets 1, 2 and the jitter between packets 4, 5 will be calculated. But since packet 3 was dropped, the jitter between packets 2, 3 and 3, 4 will not be calculated and included in the results.

The accumulated jitter, minimum jitter, maximum jitter, sum of squares, sum of cubes, jitter count, and jitter burst count are all calculated and saved in jitterStdDevSums, jitterMin, jitterMax, jitterSumSqrd, jitterSumCubed, jitterCount,

burstsReceived, respectively.

### Latency

Latency is the amount of time that a packet 200 takes to travel from the transmitter to the receiver.

The timestamp 220 when the packet 200 is transmitted is placed on the packet 200 in the SMH 230 upon transmission. When the packet 200 is received another timestamp 220 is recorded.

All the packets 200 are traversed and the average latency, maximum latency, minimum latency, sum, sum of squares, sum of cubes, and number of latencies used for calculation for all packets 200 with non-corrupted SMH headers 230 are calculated. These values are saved in the latencyAverageNumerator, latencyAverageDenominator, latencyMin, latencyMax, latencyStdDevSums, latencyStdDevSumOfSquares, latencyStdDevSumOfCubes, and latencyStdDevN fields, respectively.

### Outages

An outage occurs when a vector is not available. The causes of an outage can vary from a cable not correctly plugged in, to a router or network failure. In terms of measurement, an outage is determined if there are no measurement packets 200 received within a certain time period. This period is set by default to be 10 seconds. However, any defined time period may be used in other embodiments of the present invention. If even 1 measurement packet 200 arrives within this set time period, then no outage will occur. The first occurrence of a duplicate, counts towards a received packet 200. The remaining duplicates do not reset the outage counter. Therefore, packets 200 with errors in them do not reset the counter. The timestamp 220 of when a packet 200 is received is currently used to calculate outages.

The outage algorithm works by looping through all of the packets 200 received. Starting from the beginning of the received packets 200, the outage algorithm finds a packet 200 without errors and with no duplicates for it in the list, and saves the received timestamp 220 of the packet 200. For every packet 200, except for the first, the outage algorithm subtracts the time of the current valid packet received from the last packet's received timestamp 220. If the difference is greater than the outage trigger time (currently 10 seconds) then an outage has occurred and is recorded. The algorithm also looks for the last packet 200 received to see if there is an outage of which it can compute the length, without using the maximum of the remainder of the measurement period 102.

The result of the algorithm is the sum of all outage durations, the minimum outage duration, the maximum outage duration, and the number of outages. These values are saved in the results as: outageDurationTotal, outageDurationMin, outageDurationMax, and outages, respectively.

### Ordering

The order in which packets 200 are received (as opposed to how they are transmitted) is another set of data saved in an embodiment of the present invention. To determine ordering metrics, an algorithm is applied whose purpose is to determine how many items are out of order. The algorithm distinguishes between individual packets 200 and groups of packets. A group of packets is one in which all items in the group are in sequential order with no out of order packets there between. The end result of the algorithm is the number of groups of packets and the number of individual packets out of order. These results are stored in the rxGroupsOutOfOrder and rxPacketsOutOfOrder fields.

In an embodiment of the network metric system 10, enough RAM is used to hold a flag to represent each item in the list for which “presortedness” is to be determined. In one embodiment, this is a bit or a byte array, with each having a size or speed advantage, respectively. The algorithm performs the following tasks:

1. Mark any strings at the beginning or end of an array that are already in position.

A) Search array items, that have not been marked as moved, for the minimum and maximum number of items in the array.

B) Examine the first unmarked item in the list (maintain an index to this item) to see if it is the minimum.

If it is the minimum, then compute the length of the string which is already in place in order to simply mark the item as moved without counting the item.

Examine each consecutive item. If this item is item [−1]+1 then move on to the next one. However, if this item is greater than [−1]+1, search the entire array of unmarked items for one which is in between these two items. If found, the end of the string is found, and all these items must be marked as moved without counting them. A value less than the previous value terminate the string. If no value is found in-between, then the string continues.

C) Perform Step B again, except starting from the end of the array.

2. Next, in order to move the smallest runs first, start a variable called automark set to 1. This means that the array is searched for run lengths. If a run is found of length 1, the run is marked immediately as moved, and then counted. This variable is set to the next smallest run length found after searching the array for all runs of automark size. This prevents searching for unused run lengths on the next scan.

3. After every run is moved, the algorithm transforms the new first or last unmarked item in the array from being out of position to being in position. This will only happen if either the run has a min or max value equal to the min or max value of the array, or if the string is moved or has been moved from either the beginning or end of the array. If this is the case, then perform either 1(B) or 1(C) above, respectively.

### EXAMPLE 1

10 11 12 13 45 46 47 14 15 7 1 2 3 4 5 6 Found 7, mark as moved and count. Found 14 15, mark as moved and count. Since 14 and 15 are marked as moved, 10-47 will now be viewed as one long string. Thus, process 1-6 next. Since this string contains the min value, check the first unmarked item in the array now for min (10). Since it is the min, mark as moved without counting. Everything is in order 3 groups of 9 items.

For the following example:

MMC=Mark as Moved and Count

MMDC=Mark as Moved and Don't Count

### EXAMPLE 2

1 3 2 4 6 5 8 7

1 MMDC. 3 MMC. 2 4 MMDC. 6 MMC. 5 MMDC. 8 MMC. 7 MMDC. 3 groups 3 items.

### EXAMPLE 3

5 40 48 1 12 16 17 18 3 4 5 6 7 8 47

5 MMC. 40 MMC. 48 MMC. 47 MMDC. 1 MMDC. 12-18 MMC. 3-8 MMDC. 4 groups 7 items.

### EXAMPLE 4

41 42 43 15 40 48 1 12 16 17 18 3 4 5 6 7 8 47

Find 15 MMC. Find 40 MMC. Find 48 MMC. Since 48 max check end string 47 in position MMDC. Find 1 MMC. 41-43 found MMC. Find 12-18 MMC.

### Port Counters

Port counters are used to keep track of the number of frames, collisions, and certain types of errors calculated by the ‘layer 2’ (Ethernet layer) interface. Each data packet in the received list contains a running estimate of these items. The estimates in the first packet 200 are subtracted from the estimates in the last received packet 200 and these are stored as results for the measurement period 102.

The items saved are:

Number of good frames transmitted—estimate_txGoodFrames

Number of transmitted packets with collisions—estimate_txCollisions

Number of transmitted packets with no collisions—estimate_txNoTxCollisons

Number of good frames received—estimate_rxGoodFrames There are also various error values that are stored. These are discussed later in the Error Handling/Ethernet Errors sections.

### Ethernet Errors

The first set of errors involves errors that were found previously at the Ethernet layer. These ‘layer 2’ errors are summed in each of the appropriate fields in the results for all packets received in the measurement period. These errors are:

The number of CRC errors caused by a bad CRC—rxCRCErrors

Alignment errors—rxAlignmentErrors

Frame too short errors—rxShortFrameErrors

Frame too long errors—rxLongFrameErrors

Total received errors—rxErrors

In addition, the estimates of certain errors in the first packet 200 received are subtracted from the estimates in the last packet 200 received. These are stored as results for the measurement period 102. These ‘estimate’ values are:

The number of CRC errors caused by a bad CRC—estimate_rxCRCErrors

Alignment errors—estimate_rxAlignmentErrors

Frame too short errors—estimate_rxShortFrameErrors

Resource errors—estimate_rxResourceErrors

### SMH Header Errors

The next set of errors involves the SMH header CRC. This CRC 210 is a 64 bit value that validates the SMH header 230 items. If this CRC 210 is incorrect, critical data cannot be retrieved from the packet 200 such that it cannot be used for TTL, DSCP, latency, outage, and jitter calculations. The Ethernet payload 240 is also considered corrupted since the SMH header 230 is part of the Ethernet payload 240. If the SMH header 230 is corrupted, the packet 200 is not stored in the array of packets used for further computations and is ignored for the metrics mentioned below. These items are stored in the array of packets used for further calculations:

The received timestamp—rxTimestamp;

The transmitted timestamp—txTimestamp;

The identifier of the current packet in order transmitted—sequence;

The identifier of the burst—cBurstID;

A pointer to the packet—packet; and a general error value that signifies if there is a layer 2, payload, or SMH header error-errored.

These items cannot be calculated for the packet if the SMH header 230 is corrupted: the identifier of the period—CperiodID (only one packet received in the measurement period has to be free of SMH header errors to get this anyway);

The number of TTL changes—packetsTtlChanges and all other TTL results;

The number of protocol changes—packetsIPProtocolChanges;

The number of DSCP field changes—packetsDscpChanges and all other DSCP results; and

The latency, jitter, and outages—(depends on rxTimestamp and txTimestamp).

The following results are incremented with each corrupted SMH header found:

The number of corrupted SMH headers—packetsSMHInfoCorrupted; and

The number of payloads corrupted—packetsPayloadCorrupted.

### Other Info

Additionally, there are a few other miscellaneous items that are stored in the results. bytesReceived is the sum of the number of bytes received in total for the measurement period 102. To calculate the bytesReceived, the packets 200 are traversed and all of the bytes received for each packet 200 are summed.

Up to the first 10 DSCP fields are saved into the packetsFirst10Dscp array. To find the DSCP fields to store, all received packets with valid SMH headers 230 are traversed. The values in the DSCP fields in the SMH header 230 are examined. The values are compared and, if they differ, the DSCP field setting is saved in the packetsFirst10Dscp array. This indicates a router modified the DSCP field before re-transmitting the packet 200. The number of changes stored is placed in packetsFirst10DscpCount.

Some general vector information is also stored in the results. The packetsTransmitted, bytesTransmitted, measurementPeriodNanoseconds, and

universalTime are retrieved from the vector itself and saved.

Version information is stored in the results. This information consists of:

Transmitting and receiving main versions—txMainVersion, rxMainVersion;

Transmitting and receiving Big Joe versions—txBigjoeVersion,

rxBigjoeVersion;

Transmitting and receiving FPGA versions—txFPGAVersion,

rxFPGAVersion; and

Transmitting and receiving Mercury versions—txboardVersion,

rxboardVersion.

Transmitting and receiving the nodal member 30 temperature information is saved in the results. The minimum, maximum, average temperatures of the transmitting and receiving nodal member 30 are saved in:

txtemperatureMin, rxtemperatureMin, txtemperatureMax, rxtemperatureMax, txtemperatureAverageNumerator, rxtemperatureAverageNumerator,

txtermperatureAverageDenominator, and rxtemperatureAverageDenominator.

### Results Structure

The results structure and the elements that comprise the results structure are referenced below, and are used to store all results calculated by the measurement algorithms. In one embodiment of the present invention, reference to the result structure is a reference to the structure below.

### Atomic Packet Data Structure

In one embodiment of the present invention, this structure is used to store information for each measurement packet 200 received. A linked list of these structures for the current measurement period 102 is located initially by the measurement algorithms. The list is in order received.

### Calculation Packet Data Structure

An array of these structures is computed from the original list of AtomicPacketData structures by the measurement algorithms. This list is used to eliminate packets 200 with any SMH header 230 errors and make it easier to reference the packets 200 without traversing the list each time.

### System Operation

The logical operations of the network metric system 10 of the present invention utilize the components of the system in a logical sequence. In an embodiment of the network metric system 10, a vector is the fundamental measurement unit. A vector is defined as a packet type and source and destination pair. The packet type describes what the characteristics of the packet are. All packets for the vector have the same characteristics (i.e. packet types). Packet types include the ability to control the following: length of packet; payload type (all zero's, all one's, random, or PRBS (pseudo-random bit sequence)); Ethernet header; LLC/SNAP header; IP header; TCP/UDP header; TCP/UDP source and destination port numbers; CoS values; VLAN ID values; DSCP/DiffServe bits; record/strict/loose route information; default gateway; percentile data; Ethernet source and destination addresses; and TCP header information such as window size, MSS option, FLAGs and urgent pointer.

A vector is created by the service daemon 70. The service daemon 70 reads the configuration parameters of the vector from a database 40 and communicates with the nodal members 30 via SMAP Protocol to create the vector on the sending nodal member 30. If the nodal member 30 accepts the configuration request, the nodal member 30 responds to the service daemon 70 with an “ok” status. If the nodal member 30 does not accept the configuration request, the nodal member 30 will not create the vector and will respond with an error status. Once the vector is created on the sending nodal member 30, the service daemon 70 issues the Readiness test command (via SMAP Protocol). The readiness test includes a set of tests including the Go/NoGo test, as previously discussed.

Once again, the tests included are:

(1) Ping Receiving nodal member 30: Ping the receiving (destination) nodal member 30 and record the RTT time, execute time and IP address of the receiving nodal member 30; and

(2) Go/NoGo to receiving nodal member 30: A message with the parameters of the vector, user ID, and password are sent to the receiving nodal member 30 asking for permission to make measurements. Additionally, the Go/NoGo message also contains additional information for how the measurements are computed such as initial TTL, DSCP, CoS, VLAN ID, Ethernet destination address, Ethernet source address, IP protocol values; delay and jitter percentile preferences and so forth including a shared secret. The receiving nodal member 30 looks at the parameters and compares the user ID and password with an Access Control List (ACL) maintained within the receiving nodal member 30. If the parameters are ok, and the user ID and password matches with a valid ACL entry, then the receiving nodal member 30 responds with a GO confirmation. Once the GO confirmation is received by the sending nodal member 30, then measurements start on the next measurement period 102 (5 minute boundary). If the receiving nodal member 30 does not accept the parameters or user ID/password combination, then either a NO response is to be given to the sending nodal member 30, or a NoGo message is sent. In either negative case, the sending nodal member 30 will not under any circumstances send measurement packets 200. The feature is for security in that the users can not create vectors to systems other than nodal members 30 nor create vectors for nodal members 30 that they do not control.

Once the GO confirmation is received by the sending nodal member 30, then measurement packets 200 are sent, which are formed as shown above. The number of packets 200 sent is based on the number of total vectors within the sending nodal member 30, the characteristics of those vectors (e.g. packet size, packets/sequence) and the measurement bandwidth allocated to the sending nodal member 30. Packets are sent at the measurement bandwidth rate over the measurement period 102 (5 minutes). Every measurement period 102, the number of packets 200 sent is recalculated before the measurements packets 200 sent. Measurement packets 200 are sent until the vector is stopped or deleted.

As the receiving nodal member 30 receives measurement packets 200, the nodal member 30 pre-processes them into a unit of data referred to as an Atomic Packet. The Atomic Packet stores information such as the packet ID, Vector ID, sending nodal member agent ID, transmit timestamp, receive timestamp, original TTL value and received TTL value, as well as the status of the various regions such as UDP/TCP/Other header, payload and SMH header.

Once the measurement period 102 is over, which is indicated by a message from the sending nodal member 30, the receiving nodal member 30 processes the Atomic Packets via its algorithms (as described above). Once completed, this information may be stored between 8-48 hours. The information is then sent to the service daemon 70 via the SMAP Protocol. If the service daemon 70 does not receive the result packet until some time later than expected, or if the service daemon 70 receives a subsequent results packet, the service daemon 70 polls the nodal member 30 for the results. The service daemon 70 can poll the nodal members 30 for data that was computed or measured 8-48 hours in the past.

By computing Atomic Packets and then reducing that information down to a small amount of information (the core metrics), the Ethernet metric system 10 allows for a very scalable system that is highly distributed. In addition, since the results data is constant in size regardless of the number of measurement packets 200 sent, the system is far more efficient at storing data and reporting data.

Although the invention has been described in language specific to computer structural features, methodological acts, and by computer readable media, it is to be understood that the invention defined in the appended claims is not necessarily limited to the specific structures, acts, or media described. Therefore, the specific structural features, acts and mediums are disclosed as exemplary embodiments implementing the claimed invention.

Furthermore, the various embodiments described above are provided by way of illustration only and should not be construed to limit the invention. Those skilled in the art will readily recognize various modifications and changes that may be made to the present invention without following the example embodiments and applications illustrated and described herein, and without departing from the true scope of the present invention, which is set forth in the following claims.

What is claimed is:

1. A system for performing measurements over a network for system configuration, reporting and alarming of measurement data, the system comprising:
a plurality of nodal members between which one-way or round-trip measurements are performed over asymmetrical paths, wherein the measurements are performed at the Ethernet layer, and wherein the number of nodal members used as measurement points is scaleable;
a database, wherein the database stores measurement data recorded by the plurality of nodal members;
a workstation operatively associated with the database, wherein the workstation facilitates system configuration and reporting of measurement data; and
at least one service daemon, and wherein the service daemon interfaces with the plurality of nodal members and the database, instructs the plurality of nodal members to create vectors, obtains vector configuration information from the database, and processes results data transmitted from the plurality of nodal members to the database.

2. The system of claim 1, further comprising an application server that interfaces between the workstation and the database for system configuration and results display.

3. The system of claim 1, wherein the measurements are performed at the network layer and subsequent layers.

4. The system of claim 1, wherein the measurements performed between the plurality of nodal members are selected from a group consisting of Delay, Delay (MEF), Delay (untrimmed), Jitter/Delay Variation, Jittter/Delay Variation (untrimmed), Packet Loss, Availability, Outages, Rate Ratio, R-Factor, Transmit Bit Rate, Transmit Packet Rate, Receive Bit Rate, Receive Packet Rate, Packets Out-of-Order, Groups of Packets Out-of-Order, Sequential Packets Lost, Sequential Packets Dropped, Packets Dropped, Packets Duplicated, Packets Tagged, Packets Untagged, VLAN ID, VLAN CoS, Destination Address, Source Address, Transmit Interface, Receive Interface, Packets with CRC Errors, Packets with Alignment Errors, Packets Too Short, Packets Too Long, Accumulative to Transmit Interface, Accumulative to Receive Interface, DSCP, Packets Dropped Due to Missing Fragment, Packets Fragmented, L3 IP Header Corrupted, L4 Header Corrupted, Hop Count, L3 IP Protocol, Record/Strict/Loose Route Info, Payload Corrupted, Measurement Header Corrupted, cNode Level 1 Agent, Transmitting System Synchronization, Receiving System Synchronization, Packets, Bytes, Bursts received, Mismatched timestamps, Transmitting System, and Receiving System.

5. The system of claim 1, wherein the plurality of nodal members include multiple on-board processors, enabling one processor to handle management processes and another processor to handle measurement processes.

6. The system of claim 1, wherein the plurality of nodal members are autonomous devices that are capable of generating measurement packets, performing round-trip measurements at the Ethernet layer, processing measurement data, and temporarily storing measurement data, despite a service daemon or database outage.

7. The system of claim 1, wherein a transmitting nodal member from the plurality of nodal members performs a readiness test to ensure the willingness of a receiving nodal member from the plurality of nodal members to accept measurement traffic before the transmitting nodal member begins to transmit measurement traffic to the receiving nodal member.

8. The system of claim 7, wherein the readiness test comprises: pinging the receiving nodal member; and performing a Go/No Go test using an SMAP communication protocol, wherein the SMAP communication protocol is a non-processor intensive, non-bandwidth intensive protocol for the plurality of nodal members to communicate with each other.

9. The system of claim 8, wherein the Go/No Go test is performed by a transmitting nodal member requesting and obtaining permission from a receiving device to transmit measurement traffic before the transmitting nodal member transmits the measurement traffic, thereby ensuring protection against unwanted measurements being made on nodal members and against measurement traffic being sent to a non-nodal member receiving device.

10. The system of claim 4, wherein the plurality of nodal members are capable of generating a measurement packet comprising an Ethernet CRC, a measurement header, a payload, an Optional Header, an IP Header options, and an Ethernet Header.

11. The system of claim 6, wherein the plurality of nodal members having the ability to hardware time stamp the measurement packet upon transmitting and receiving the measurement packet.

12. The system of claim 11, wherein a transmit hardware time stamp is stored within a scalable measurement header on the measurement packet and the transmitting nodal member.

13. The system of claim 11, wherein a receiving hardware time stamp is stored on the measurement packet received by the nodal member.

14. The system of claim 1, wherein measurement data from a plurality of measurement periods is sent from the plurality of nodal members to the database via an SMAP communication protocol.

15. The system of claim 1, wherein the data stored in the database is selected from the group consisting of: code version; nodal member ID; vector ID; measurement period ID; universal time; length of measurement period; number of packets and bytes sent and received in the measurement sequence; anomalies, including out of order, duplicated, fragmented, dropped, IP-corrupted, payload-corrupted, SMH information corrupted; TTL changes, DSCP changes, minimum/maximum/average/standard deviation for one-way latency and jitter, and route information.

16. The system of claim 1, wherein the plurality of nodal members facilitate user-definable bandwidth allocation for measurement traffic.

17. The system of claim 1, wherein the measurements performed are continuous.

18. A method for performing quality and functionality measurements over a network, the method comprising:
performing a round-trip measurement between at least two nodal members from a plurality of nodal members over asymmetrical paths, wherein the measurements are performed at the Ethernet layer in a scalable environment;
processing data produced from the round-trip measurements between the plurality of nodal members; and
transmitting the processed measurement data from the plurality of nodal members to a database; and
analyzing the processed measurement data.

19. The method of claim 18, wherein the measurement performed between at least two nodal members from the plurality of nodal members over asymmetrical paths is a one-way measurement.

20. The method of claim 18, wherein the processed measurement data is transmitted via at least one service daemon that interfaces with the plurality of nodal members and the database, wherein the at least one service daemon instructs the plurality of nodal members to create vectors, obtains vector configuration information from the database, and processes results data transmitted from the plurality of nodal members to the database; and providing for system management capabilities and measurement data analysis via a workstation.

21. The method of claim 18, wherein the workstation utilizes a browser based interface to provide system reports and management functions to a user from any computer connected to the Internet without requiring specific hardware or software.

22. The method of claim 18, wherein the performing of the round-trip measurements between at least two nodal members from the plurality of nodal members is achieved by transmitting measurement packets with SMH headers between the nodal members.

23. The method of claim 18, wherein the plurality of nodal members implement a processing algorithm on raw measurement data recorded for a plurality of measurement periods, and wherein the processing algorithm compresses the raw measurement data.

24. A method for performing quality and functionality measurements over a network, the method comprising:
performing a round-trip measurement between a nodal member from a plurality of nodal members and a nodal agent over asymmetrical paths, wherein the measurements are performed at the Ethernet layer in a scalable environment;
processing data produced from the round-trip measurements between the nodal member and the nodal agent; and
transmitting the processed measurement data from the nodal member to a database; and
analyzing the processed measurement data.

25. The method of claim 24, wherein the round-trip measurement is comprised of:
transmitting a measurement packet from the nodal member to the nodal agent, the measurement packet having a destination address and a source address;
receiving the measurement packet on the nodal agent;
replacing the source address of the measurement packet with a source address value of the nodal agent;
replacing the destination address of the measurement packet with the source address of the measurement packet; and
retransmitting the measurement packet to the nodal member.

26. A system for performing measurements over a network, the system comprising:
a nodal member and a nodal agent between which round-trip measurements are performed over asymmetrical paths, wherein the measurements are performed at the Ethernet layer, and wherein the number of nodal members used as measurement points is scaleable;
a database, wherein the database stores measurement data recorded by the plurality of nodal members;
a workstation operatively associated with the database, wherein the workstation facilitates system configuration and reporting of measurement data; and
at least one service daemon, and wherein the service daemon interfaces with the plurality of nodal members and the database, instructs the plurality of nodal members to create vectors, obtains vector configuration information from the database, and processes results data transmitted from the plurality of nodal members to the database.

27. The system of claim 26, wherein the round-trip measurement is comprised of:
a nodal member transmitting a measurement packet having a destination and a source address;
a nodal agent for receiving the measurement packet, the nodal agent replacing the source address of the measurement packet with a source address value of the nodal agent, the nodal agent replacing the destination address of the measurement packet with the source address of the measurement packet; and
the nodal agent transmitting the measurement packet to the nodal member.

28. A system for performing measurements over a network, the system comprising:
a nodal network that includes multiple nodal members between which one-way or round-trip measurements are performed at the Ethernet layer, and wherein the nodal members implement hardware time stamping, thereby offloading the processor-intensive activity of time stamping and freeing up processing power;
a database, wherein the database storing measurement data;
a workstation, wherein the workstation provides a user interface for system configuration and reporting of measurement data;
an application server, wherein the application server interfaces between the database and the workstation for system configuration and results display; and
at least one service daemon, and wherein the service daemon interfaces with the nodal network and the database, instructs the nodal members to create vectors, obtains vector configuration information from the database, and processes results data transmitted from the nodal members to the database.

29. The system of claim 28, wherein the vectors created by the nodal members include a source address, a destination address, and a service type.

30. They system of claim 28, wherein the vectors are configured to measure multiple classes of service.
